(19) United States
(12) Patent Application Publication
(10) Pub. No.: US 2014/0036268 A1
(43) Pub. Date: Feb. 6, 2014

(54) COMPOSITE SUBSTRATE, LSPR SENSOR INCLUDING THE SAME, METHOD OF USING LSPR SENSOR, AND DETECTION METHOD USING LSPR SENSOR

(71) Applicant: NIPPON STEEL & SUMIKIN CHEMICAL CO., LTD., Tokyo (JP)

(72) Inventors: YASUSHI ENOMOTO, CHIBA (JP); YASUFUMI MATSUMURA, CHIBA (JP); RYUZO SHINTA, CHIBA (JP)

(73) Assignee: NIPPON STEEL & SUMIKIN CHEMICAL CO., LTD., Tokyo (JP)

(21) Appl. No.: 13/954,994

(22) Filed: Jul. 31, 2013

(30) Foreign Application Priority Data
Jul. 31, 2012 (JP) 2012-169653

(51) Int. Cl. G01N 21/55; G02B 5/00

(52) U.S. Cl. CPC G01N 21/554; G02B 5/008
USPC 356/445; 428/312.8

(57) ABSTRACT

A composite substrate is described, including a laminate of a metal fine-particle dispersed layer and a light transmission layer. The metal fine-particle dispersed layer includes a matrix having a solid framework and voids therein, and metal fine-particles immobilized in the solid framework. The solid framework has a 3D network structure of aluminum oxyhydroxide or alumina hydrate. The metal fine-particles have a mean particle diameter of 20 to 100 nm, with 50% or more having particle diameters in the same range. The metal fine-particles are separated from each other, with a distance greater than or equal to the particle diameter of the larger one of neighboring fine-particles. The metal fine-particles have portions exposed in the voids of the matrix, and are 3D-dispersed in the matrix. The metal fine-particle dispersed layer has a thickness of 0.5 to 5 μm and a metal fine-particle content of 22 to 900 μg/cm².

### CROSS-REFERENCE TO RELATED APPLICATION

This application claims the priority benefit of the Japan Patent Application No. 2012-169653 filed on Jul. 31, 2012. The entirety of the above-mentioned patent application is hereby incorporated by reference herein and made a part of this specification.

### BACKGROUND OF THE INVENTION

1. Field of Invention

This invention relates to a composite substrate that may utilize the local surface plasmon resonance (LSPR), an LSPR sensor including the substrate, a method of using the LSPR sensor, and a detection method using the LSPR sensor.

2. Description of Related Art

Nano-size particle has a geometrically high specific surface area and a quantum mechanical size effect, and exhibits altered optical properties, a lower melting point, higher catalytic effects, and better magnetic properties, etc. Therefore, the nano-size particle is expected to have new functions that cannot be obtained with bulk materials, such as improved chemical and physical conversion properties including catalytic effect, light-emitting property, etc., and has become a very important material in various fields such as electronic materials, catalytic materials, phosphor materials, light-emitter materials, and medical materials, etc. Particularly, in a metal fine-particle with a size of several to 100 nanometers, the electrons interact and resonate with light of a specific wavelength. This phenomenon is known as local surface plasmon resonance (LSPR). Recently, LSPR was actively studied for application in various devices. Because the LSPR is sensitive to the change of the dielectric constant ∈ₘ(λ) [∝(nₘ(λ))², wherein nₘ is the refractive index] of the medium around the metal fine-particles, it has a characteristic that the resonance wavelength changes in response to a change in the dielectric constant (or refractive index) of the medium around the metal fine-particles. Due to the characteristic, the application of LSPR in the fields of sensing such as frost sensors, humidity sensors, bio-sensors, and chemical sensors, etc., have been investigated actively.

A conventional technique utilizing a detection of scattered light from LSPR, which uses a microscope to detect scattered light from LSPR of a single metal nano-particle among the metal nano-particles immobilized on the substrate in a 2D manner, has been proposed (e.g., in Non-Patent Documents 1, 2 and 3). For the prior art utilizes LSPR of a single metal nano-particle, there are problems such as low intensity of the scattered light and requirements of a complicated apparatus and a high-end measuring method. Moreover, detecting scattered light from LSPR in a liquid cell using a gold colloidal solution has also been proposed (e.g., in Patent Documents 3 and 4). However, because such technique utilizes gold colloidal, it is limited to be used in liquids, and the upper limit of the content of the metal fine-particles in the liquid cell is limited so that an increase of the intensity of the scattered light is limited.

### PRIOR-ART DOCUMENTS

### Non-Patent Documents

[Non-Patent Document 1] Masayuki Abe, Kazuhiko Fujiwara, Masaru Kato, Yoichi Akagami and Nobuaki Ogawa, Journal of Japan Society for Analytical Chemistry, Vol. 56, No. 9, pp. 695-703 (2007).
[Non-Patent Document 2] A. D. McFarland, R. P. Van Duyne, Nano Letters, Vol. 3, No. 8, 1057-1062 (2003).
[Non-Patent Document 3] “Recent Advances on Design and Applications of Plasmonic Nanomaterials”, supervised by Sunao Yamada, and published by CMC Publishing Co., Ltd. on Jun. 15, 2006, p. 141-150.
[Non-Patent Document 4] K. Aslan, J. R. Lakowicz, C. D. Geddes, Analytical Chemistry, Vol. 77, No. 7, 2007-2014 (2005)

### SUMMARY OF THE INVENTION

Accordingly, this invention provides a composite substrate that utilizes scattered light from LSPR and can be suitably used in various devices, an LSPR sensor including the composite substrate, a method of using the LSPR sensor, and a detection method using the LSPR sensor.

After active studies with respect to the foregoing, the Inventors discovered that the above problems can be solved by using a composite material that is dispersed with metal fine-particles immobilized in a matrix having a 3D network structure.

The composite material of this invention includes a metal fine-particle dispersed layer and a light transmission layer laminated with the same. The metal fine-particle dispersed layer has the following features a) to f). Feature a) is that the metal fine-particle dispersed layer includes a matrix having a solid framework and voids formed by the solid framework, and metal fine-particles immobilized in the solid framework. Feature b) is that the solid framework contains aluminum oxyhydroxide or an alumina hydrate to form a three-dimensional network structure. Feature c) is that the metal fine-particles have a mean particle diameter in a range of 20 to 100 nm, with a proportion of 50% or more thereof having particle diameters in the range of 20 to 100 nm. Feature d) is that the metal fine-particles are separated from each other with a distance that is greater than or equal to a particle diameter of a larger one of neighboring fine-particles. Feature e) is that the metal fine-particles have portions exposed in the voids of the matrix and are three-dimensionally dispersed in the matrix. Feature f) is that the metal fine-particle dispersed layer has a thickness in a range of 0.5 to 5 μm and a metal fine-particle content with a range of 22 to 900 μg/cm².

In an embodiment, the void proportion of the metal fine-particle dispersed layer is within the range of 15 to 95%.

In an embodiment, the volume fraction of the metal fine-particles in the metal fine-particle dispersed layer in within the range of 1 to 9% relative to the metal fine-particle dispersed layer.

In an embodiment, the metal fine-particles include gold (Au) or silver (Ag).

In an embodiment, the metal fine-particles are able to interact with light having a wavelength of 380 nm or longer to induce a local surface plasmon resonance (LSPR).

The LSPR sensor of this invention includes the composite substrate of claim 1, a light source irradiating the composite substrate with light, a light receptor receiving a scattered light from LSPR of the metal fine-particles in the composite substrate; and a spectrometer measuring the scatter spectrum of the scattered light, or a photo-detector measuring the intensity of the scattered light.

In an embodiment, the LSPR sensor further includes a means for concentrating the scattered light.

In an embodiment, the LSPR sensor further includes a means for concentrating the irradiation light.

In an embodiment, the irradiation light from the light source is inclined with respect to a lamination direction of the composite substrate.

In an embodiment, the light irradiation and the measurement of the scatter spectrum are accomplished through the light transmission layer.

The method of using the LSPR sensor of this invention includes exposing, in the atmosphere or a gas, or in a liquid, the metal fine-particle dispersed layer in the LSPR sensor.

The detection method of this invention is for detecting an inorganic or organic substance, including: providing the above LSPR sensor, and measuring the change of the scatter spectrum of the scattered light from the LSPR, the change of the intensity of the scatter spectrum of the scattered light from the LSPR, or the change of the intensity of the scattered light from the LSPR.

The composite substrate of this invention can increase the intensity of the scatter spectrum of LSPR, for the metal fine-particle dispersed composite has a matrix with a 3D network structure having a solid framework and voids formed thereby, in which the metal fine-particles are 3D-dispersed. Moreover, by controlling the particle diameter of the metal fine-particles in the matrix within the predetermined range, the particles can be dispersed evenly to maintain the inter-particle distance, so the scatter spectrum of LSPR is sharp. Furthermore, because the metal fine-particles have portions exposed in the voids in the matrix network, the characteristic that the resonance wavelength changes in response to change in the dielectric constant (or refractive index) of the medium around the metal fine-particles can be taken advantage to the maximal extent, so the composite substrate of this invention are suitably applied to the devices taking advantage of the characteristic.

In order to make the aforementioned and other objects, features and advantages of this invention comprehensible, a preferred embodiment accompanied with figures is described in detail below.

### BRIEF DESCRIPTION OF THE DRAWINGS

FIG. 1 illustrates a cross-sectional view of a composite substrate according to an embodiment of this invention.

FIG. 2 schematically illustrates the dispersion state of the metal fine-particles in a cross section of the nano-composite in the thickness direction.

FIG. 3 schematically illustrates the dispersion state of the metal fine-particles in a cross section of the nano-composite of FIG. 2 parallel with the surface of the same.

FIG. 4 illustrates the structure and the arrangement of the metal fine-particles.

FIG. 5 illustrates a locally magnified view of a nano-composite having a binding species (ligand) according to an alternative embodiment of this invention.

FIG. 6 illustrates a specific binding based on the binding species.

FIG. 7 schematically illustrates the constitution of an LSPR sensor according to an embodiment of this invention.

FIGS. 8A and 8B respectively show the absorption spectrum of LSPR and the scatter spectrum of LSPR observed in Example 1.

FIGS. 9A and 9B respectively show the absorption spectrum of LSPR and the scatter spectrum of LSPR observed in Example 7.

FIGS. 10A and 10B respectively show the absorption spectrum of LSPR and the scatter spectrum of LSPR observed in Comparative Example 1.

### DESCRIPTION OF EMBODIMENTS

The embodiments of this invention will be described in details as follows in reference of appropriate drawings.

### [Composite Substrate]

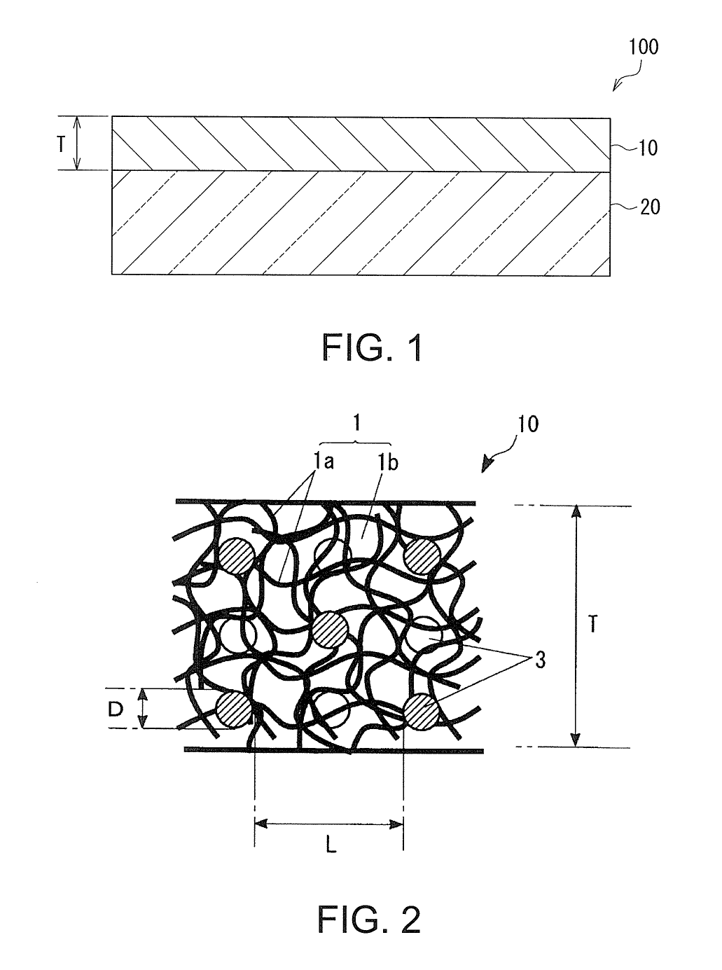

FIG. 1 schematically illustrates a cross-sectional view of a composite substrate 100 according to an embodiment of this invention. The composite substrate 100 includes a metal fine-particle dispersed layer (called “nano-composite layer” hereafter) 10 and an optically light transmission layer 20 laminated with the nano-composite layer 10. The structure and fabrication method of the nano-composite layer 10 and those of the light transmission layer will be described in sequence.

### <Metal Fine-Particle Dispersed Layer (Nano-Composite Layer)>

The metal fine-particle dispersed layer 10 has the following features a) to f). Feature a) is that the metal fine-particle dispersed layer 10 includes a matrix having a solid framework and voids formed by the solid framework, and metal fine-particles immobilized in the solid framework. Feature b) is that the solid framework contains aluminum oxyhydroxide or an alumina hydrate to form a 3D network structure. Feature c) is that the metal fine-particles have a mean particle diameter in a range of 20 to 100 nm, with a proportion of 50% or more thereof having particle diameters in the range of 20 to 100 nm. Feature d) is that the metal fine-particles are separated from each other with a distance that is greater than or equal to a particle diameter of a larger one of neighboring fine-particles. Feature e) is that the metal fine-particles have portions exposed in the voids of the matrix and are three-dimensionally dispersed in the matrix. Feature f) is that the metal fine-particle dispersed layer has a thickness in the range of 0.5 to 5 μm and a metal fine-particle content in the range of 22 to 900 μg/cm².

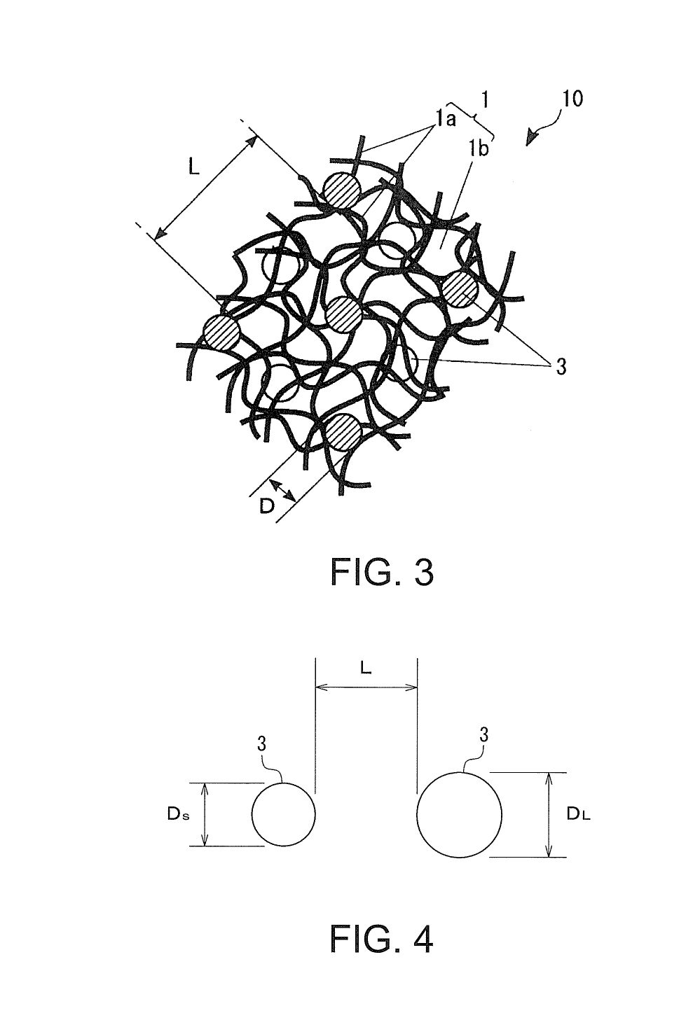

FIG. 2 schematically illustrates the dispersion state of the metal fine-particles 3 in a cross section of the nano-composite in the thickness direction. FIG. 3 schematically illustrates the dispersion state of the metal fine-particles 3 in a cross section of the nano-composite in the planar direction. FIG. 4 illustrates the arrangement of the metal fine-particles 3. Moreover, in FIG. 4, the particle diameter of the larger one of neighboring metal fine-particles 3 is represented by “D_{L}” and that of the smaller one represented by “D_{S}”. Both particle diameters are represented by “D” when they are not distinguished.

### (Matrix)

As shown in FIGS. 1-2, the matrix 1 has a solid framework 1a and voids 1b defined by the solid framework 1a. The solid framework 1a contains aluminum oxyhydroxide or an alumina hydrate to form a 3D network structure. The solid framework 1a is an aggregate of a fine inorganic filler (or crystal) of a metal oxide containing aluminum oxyhydroxide or an alumina hydrate. The inorganic filler has a particle shape, a scaly shape, a plate shape, a needle shape, a fibrous shape or a cubic shape, etc. Such a 3D network structure based on an aggregate of an inorganic filler is preferably obtained by heating a slurry formed by dispersing an inorganic filler of a metal oxide containing aluminum oxyhydroxide or an alumina hydrate in a solution. Moreover, because the metal oxide containing aluminum oxyhydroxide or an alumina hydrate is a thermo-resistant material, it is advantageous when the metal ion for forming the metal fine-particles 3 is heated and reduced, and is preferred in view of the chemical stability. Further, as aluminum oxyhydroxide (or alumina hydrate) materials, boehmite (including pseudo-boehmite), gibbsite, diaspora and so on have been known, wherein boehmite is particularly preferred. Details of boehmite are described later.

Though the solid framework 1a contains aluminum oxyhydroxide or alumina hydrate that easily forms a 3D network structure, it may further contains silicon oxide (silica), aluminum oxide (alumina), titanium oxide, vanadium oxide, tantalum oxide, iron oxide, magnesium oxide, zirconium oxide, an inorganic oxide containing a plurality of metal elements, or a combination of two or more of the above oxides.

Such a characteristic structure of the matrix 1 is intended to allow permeation of gas or liquid and thereby improve the utilization efficiency of the metal fine-particles 3. In order to efficiently utilize the high specific surface area or high activity of the metal fine-particles 3, the void proportion of the nano-composite layer 10 is preferably within the range of 15 to 95%. The void proportion of the nano-composite layer 10 can be calculated by the later-described Eq. (A) from the apparent (gross) density of the nano-composite layer 10 calculated from its area, thickness and weight, and the void-free density (real density) calculated from the intrinsic densities and the composition ratio of the material forming the solid framework and the metal fine-particles 3. When the void proportion of the nano-composite layer 10 is less than 15%, the openness to the ambient environment is low, and the utilization efficiency of the metal fine-particles 3 tends to be low. On the other hand, when the void proportion of the nano-composite layer 10 exceeds 95%, the content of the solid framework 1a or the metal fine-particles 3 is low, so the mechanical strength and the LSPR effect of the metal fine-particles 3 tend to be low.

When the nano-composite layer 10 is used in applications utilizing LSPR, the matrix 1 preferably has a light transparency allowing generation of LSPR of the metal fine-particles, and preferably includes a material transparent to light of 380 nm or more.

### (Metal Fine-Particle)

In view of controlling the particle diameter D and the inter-particle distance L of the metal fine-particles 3 in the nano-composite layer 10, the metal fine-particles 3 is preferably obtained by heating and reducing a metal ion as the precursor thereof. Such obtained metal fine-particles 3 may include a metal species, such as gold (Au), silver (Ag), copper (Cu), cobalt (Co), nickel (Ni), palladium (Pd), platinum (Pt), tin (Sn), rhodium (Rh), or iridium (Ir), etc. Moreover, an alloy of two or more of these metal species, such as a Pt—Co alloy, may also be used. Among the above metal species, those particularly suitable for inducing LSPR are Au, Ag, Cu, Pd, Pt, Sn, Rh and Ir. To interact with light having a wavelength of 380 nm or more in the visible region and induce LSPR, the preferred metal species include Au, Ag and Cu, wherein Au is more desired for difficult surface oxidation and higher preservation stability.

The metal fine-particles 3 may have various shapes, such as a spherical shape, an ellipsoid shape, a cubic shape, a truncated tetrahedral shape, a bipyramid shape, a regular octahedral shape, a regular decahedral shape, and a regular icosahedral shape, etc., but more preferably has a spherical shape to sharpen the scatter spectrum of LSPR. The shape of the metal fine-particles 3 can be identified using a transmission electron microscope (TEM). The mean particle diameter of the metal fine-particles 3 is defined as the area-averaged diameter of arbitrary 100 metal fine-particles 3 being measured. Moreover, the spherical metal fine-particles 3 are defined as metal fine-particles having a spherical shape or a nearly spherical shape, wherein the ratio of the average long diameter to the average short diameter is 1 or close to 1 (preferably ≦0.8). Moreover, regarding the relationship between the long diameter and the short diameter of any individual metal fine-particle 3, it is preferred that the long diameter is less than 1.35 times the short diameter, and is more preferred that the long diameter is equal to or less than 1.25 times the short diameter. Moreover, when the metal fine-particles 3 do not have a spherical shape but have, for example, a regular octahedral shape, the largest one among the edge lengths of a metal fine-particle 3 is taken as the long diameter of the same, the smallest one among the edge lengths is taken as the short diameter of the same, and the above long diameter is considered as the particle diameter D of the same.

In the nano-composite layer 10 of this embodiment, the metal fine-particle 3 is preferably capable of interacting with light to induce LSPR. The wavelength range allowing induction of LSPR depends on the particle diameter D, the particle shape, the metal species, the inter-particle distance L, the refractive index of the matrix 1, and so on, but light having a wavelength of 380 nm or more is preferably used to interact with the metal fine-particles 3 to induce LSPR.

The metal fine-particles 3 have a mean particle diameter in a range of 20 to 100 nm, with a proportion of 50% or more thereof having particle diameters in the range of 20 to 100 nm. The so-called “mean particle diameter” means the average value of the diameters (i.e., the medium diameter) of the metal fine-particles 3. Moreover, the “proportion of the metal fine-particles 3” means the volume proportion or weight proportion based on the total amount of the metal fine-particles 3, but not a number proportion. The scattered light is more intense when the particle diameter D is larger, but the scatter spectrum of LSPR becomes broad as the mean particle diameter of the metal fine-particles 3 exceeds 100 nm. On the other hand, when the mean particle diameter of the metal fine-particles 3 is less than 20 nm, scattered light from LSPR is difficult to occur. Moreover, when the proportion of the metal fine-particles 3 having particle diameters in the range of 20 to 100 nm is less than 50%, light scattering is difficult to occur. Moreover, with the proviso that the mean particle diameter of the metal fine-particles 3 is within the range of 20 to 100 nm, it is preferred that the proportion of the metal fine-particles 3 having a particle diameter D of 50 nm or more is 70% or more and the proportion of the metal fine-particles 3 having a particle diameter D of 20 nm or more is 90% or more. Moreover, in order to sharpen the scatter spectrum of LSPR, the particle-diameter distribution of the metal fine-particles 3 is preferably controlled to be small. However, the particle-diameter distribution of the metal fine-particles 3 is not particularly limited.

### (Presence State of Metal Fine-Particles)

In the matrix 1, the metal fine-particles 3 are present independently without contacting with each other, and in particular, are preferably present with a distance greater than or equal to the particle diameter of the larger one of neighboring metal fine-particles 3. That is, the distance (inter-particle distance) L between neighboring metal fine-particles 3 is greater than or equal to the particle diameter D_{L} of the larger one of the neighboring metal fine-particles 3 (L≧D_{L}). As shown in FIG. 4, the inter-particle distance L of the metal fine-particles 3 is greater than or equal to the particle diameter D_{L} of the larger metal fine-particle 3. Therefore, the LSPR characteristic of the metal fine-particle 3 can be exhibited efficiently. Moreover, the relationship between the particle diameter D_{L} of the larger one of neighboring metal fine-particles 3 and the particle diameter D_{S} of the smaller one may be “D_{L}≧D_{S}”. For the nano-composite layer 10 of this embodiment, the state that the metal fine-particles 3 are dispersed in the matrix 1 with an inter-particle distance greater than or equal to the particle diameter D_{L} of the larger one of neighboring metal fine-particles 3 can be achieved by heating and reducing a metal ion as a precursor of the metal fine-particles 3 so that the separated metal fine-particles 3 easily diffuse due to the heat. When the inter-particle distance is less than the particle diameter D_{L} of the larger one of neighboring metal fine-particles 3, interference between the LSPR of neighboring particles occurs. For example, there are cases where neighboring particles cooperate as a large particle to induce LSPR so that a sharp scatter spectrum is difficult to obtain. On the other hand, though a larger inter-particle distance L has no particular problem, its upper limit is preferably controlled based on the lower limit of the volume fraction of the metal fine-particles 3 because the inter-particle distance L of the metal fine-particles 3 having the dispersion state due to thermal diffusion is closely correlated to the particle diameter D of the metal fine-particles 3 and the volume fraction of the same described later. When the inter-particle distance L is large, namely when the volume fraction of the metal fine-particles 3 relative to the nano-composite layer 10 is small, the intensity of the scatter spectrum of LSPR is low. In such a case, the intensity of the scatter spectrum of LSPR can be increased by increasing the thickness T of the nano-composite layer 10.

In the nano-composite layer 10 of this embodiment, the metal fine-particles 3 have portions exposed in the voids 1b in the matrix 1 and are 3D-dispersed in the matrix 1. That is, because the metal fine-particles 3 are efficiently arranged in a 3D manner in a state of high specific surface area, the utilization efficiency of the metal fine-particles 3 can be raised. Moreover, because the metal fine-particles 3 have portions exposed in the voids 1b communicating with the ambient environment, the characteristic of being sensitive to the change of the dielectric constant ∈ₘ(λ) [∝(nₘ(λ))², wherein nₘ is the refractive index] of the medium around the metal fine-particles 3 can be developed. Accordingly, it is possible to fully utilize the characteristic of the metal fine-particles 3 that the resonance wavelength changes in response to a change of the dielectric constant (or refractive index) of the medium around the metal fine-particles 3. Such structural feature of the nano-composite layer 10 is most desired when the nano-composite layer 10 is used in applications utilizing LSPR, such as various sensors such as frost sensors, humidity sensors, gas sensors, bio-sensors, chemical sensors and so on.

Moreover, as shown in FIGS. 2 and 3, when the nano-composite layer 10 is observed at a cross section along the thickness direction of the matrix 1 having a 3D network structure, i.e., the lamination direction of the composite substrate 100, and observed at a cross section along a direction perpendicular to the thickness direction, i.e., a cross section parallel with the surface of the matrix 1, a plurality of metal fine-particles 3 are dottedly distributed in the longitudinal direction and the transverse direction with an inter-particle distance greater than or equal to the above particle diameter D_{L}.

Moreover, in the nano-composite layer 10, it is preferred that 90% or more (more preferably 100%) of the metal fine-particles 3 are single particles dottedly distributed with an inter-particle distance L greater than or equal to the above particle diameter D_{L}. Herein, the so-called “single particles” means metal fine-particles 3 that are present independently in the matrix 1, but do not include aggregates of multiple particles (aggregated particles). That is, the single particles do not include aggregated particles formed by aggregation of multiple metal fine-particles through an inter-molecular force. Moreover, an “aggregated particle” can be clearly identified by, for example, an observation using a transmission electron microscope (TEM), to be one aggregate formed by assembly of multiple individual metal fine-particles. Moreover, though in terms of chemical structure, the metal fine-particles 3 in the nano-composite 10 are known to be metal fine-particles formed by aggregation of metal atoms formed by thermal reduction, they are considered to be formed by metal bonding of metal atoms and be different from the aggregated particles formed by aggregation of multiple particles. For example, when a transmission electron microscope (TEM) is used to observe, a single independent metal fine-particle 3 can be identified. By making the above single particles present in a proportion of 90% or more, the absorption spectrum of LSPR is sharp and stable, and a high detection sensitivity is obtained. This means, in other words, that the proportion of the aggregated particles or the particles dispersed with an inter-particle distance L less than the above particle diameter D_{L} is less than 10%. If such particles are present in a proportion of 10% or more, the scatter spectrum of LSPR gets broad and unstable, and a high detection precision is difficult to obtain when the nano-composite layer 10 is utilized in devices such as sensors. Moreover, if the proportion of the aggregated particles or the particles dispersed with an inter-particle distance L less than the above particle diameter D_{L} exceeds 10%, controlling the particle diameters D is very difficult.

Moreover, the volume fraction of the metal fine-particles 3 in the matrix 1 is preferably in the range of 1 to 9% relative to the nano-composite layer 10. Herein, the so-called “volume fraction” is a value indicating the percentage of the total volume of the metal fine-particles 3 in a certain volume of the nano-composite 10 containing the voids 1b. If the volume fraction of the metal fine-particles 3 is less than 1%, the particle diameter is less than 20 nm, so that a scattered light from LSPR hardly occurs, and the effect of this invention is difficult to obtain even when the thickness T of the nano-composite layer 10 is large. On the contrary, if the volume fraction exceeds 9%, the distance (inter-particle distance L) between neighboring metal fine-particles 3 is less than the particle diameter D_{L} of the larger one of neighboring metal fine-particles 3, so that a sharp peak in the scatter spectrum of LSPR is difficult to obtain.

Moreover, the content of the metal fine-particles 3 in the nano-composite layer 10 is preferably within the range of 22 to 900 μg/cm². When the content is less than 22 μg/cm², the particle diameter of the metal fine-particles 3 is less than 20 nm, so that a scattered light from LSPR hardly occurs, and the effect of this invention is difficult to obtain even when the thickness T of the nano-composite layer 10 is large. On the contrary, if the content exceeds 900 μg/cm², the distance (inter-particle distance L) between neighboring metal fine-particles 3 is less than the particle diameter D_{L} of the larger one of the neighboring metal fine-particles 3, so that a sharp peak in the scatter spectrum of LSPR is difficult to obtain.

When a cross section of the matrix 1 of the nano-composite layer 10 is observed possibly by TEM or the like, overlapping of the metal fine-particles 3 with each other is seen in the matrix 1 with the transmitted electron beam. However, the metal fine-particles 3 are actually distant from each other by a certain distance or more, and are dispersed as completely independent single particles. Moreover, because the metal fine-particles 3 are physically or chemically immobilized in the 3D network-like solid framework 1a containing aluminum oxyhydroxide or alumina hydrate, aggregation or falling of the metal fine-particles 3 accompanying with time-dependent change can be prevented. Hence, the long-term preservability is excellent, and aggregation or falling of the metal fine-particles 3 can be inhibited even after the nano-composite layer 10 has been used repeatedly. Particularly, since aggregation of the metal fine-particles 3 is not seen even after long-term preservation in room temperature when the solid framework 1a contains aluminum oxyhydroxide or alumina hydrate, such a solid framework 1a is considered to be highly effective in the chemical immobilization of the metal fine-particles 3.

### <Fabrication Method>

Next, the method for fabricating the nano-composite layer 10 is described, which is the following method (I) or (II), for example. In view of reducing the number of the fabrication steps, the method (I) is preferred.

The method (I) includes the following steps Ia to Id. In the method (I), it is also possible to mix a polyvinylalcohol in the slurry of the step Ia or the coating liquid of the step Ib and perform the steps Ic and Id in the presence of the polyvinylalcohol.

The step Ia is to prepare a slurry containing aluminum oxyhydroxide or an alumina hydrate for forming the solid framework 1a.

The step Ib is to prepare a coating liquid by mixing, in the slurry, a metal compound as a raw material such that the metal element therein has an amount of 7.5 to 480 weight parts (having been converted to the amount of its metallic form throughout this specification) relative to 100 weight parts of the solid content of the slurry.

The step Ic is to coat the substrate with the above coating liquid and dry the coating liquid to form a coated film.

The step Id is to perform a heating treatment to form, from the coated film, a matrix 1 including a solid framework 1a with a 3D network structure and voids 1b defined by the solid framework 1a, and simultaneously thermally reduce the metal ion of the metal compound to separate particle-shaped metal as the metal fine-particles 3. Thus, the nano-composite layer 10 is obtained.

The method (II) includes the following steps IIa to IId. In the method (II), it is also possible to mix a polyvinylalcohol in the metal ion containing solution of the step IIc and perform the step IId in the presence of the polyvinylalcohol.

The step IIa is to prepare a slurry containing aluminum oxyhydroxide or an alumina hydrate for forming the solid framework 1a.

The step IIb is to coat the substrate with the above slurry, dry the slurry, and then perform a heating treatment to form a matrix 1 including a solid framework 1a with a 3D network structure and voids 1b defined by the solid framework 1a.

The step IIc is to impregnate the matrix 1 with a solution containing a metal ion as a raw material of the metal fine-particles 3, such that the metal element therein has an amount of 7.5 to 480 weight parts relative to 100 weight parts of the solid content of the slurry.

The step IId is to perform a heating treatment to reduce the metal ion and separate particle-shaped metal as the metal fine-particles 3. Thus, the nano-composite layer 10 is obtained.

Though the respective steps in methods (I) and (II) will be described specifically, the common parts therefore will be described together. Herein, a case where the solid framework 1a of the matrix 1 is constituted by boehmite (including pseudo-boehmite) will be described as a representative example.

Boehmite is high-crystallinity fine-particles of aluminum oxyhydroxide (AlOOH) or alumina hydrate (Al₂O₃.H₂O), and pseudo-boehmite is low-crystallinity fine-particles, both of which are just called “boehmite” when they are not to be distinguished. The boehmite powder can be produced by a well-known method, such as neutralization of an aluminum salt or hydrolysis of an aluminum alkoxide. Because the boehmite powder can be advantageously utilized as the component constituting the solid framework 1a of the matrix 1 because it is insoluble in water and is resistance to organic solvents, acids and alkalis, and can be easily prepared in the form of slurry because it is characterized in being highly dispersible in an acidic aqueous solution. The boehmite powder having a particle shape of a cubic shape, a needle shape, a rhombic-plate shape, an intermediate shape of these shapes or a wrinkled-sheet shape and having a mean particle diameter of 10 nm to 2 μm can be utilized preferably. The end surfaces or surfaces of the fine-particles are bonded to form the solid framework 1a, which can form a 3D network structure. Moreover, the mean particle diameter of the boehmite powder is the value derived with laser diffraction.

The boehmite powder as a raw material preferably has a primary particle diameter of 200 nm or less and a secondary particle diameter of 0.025 to 2 μm for secondary particles as aggregates of the primary particles. When the boehmite powder used as the major component of the raw material for forming the solid framework 1a of the matrix 1 has primary and secondary particle diameter within the above ranges, the dispersibility of the metal fine-particles 3 can be improved. If the primary particle diameter of the boehmite exceeds 200 nm, the voids 1b tend to be overly large. If the secondary particle diameter is less than 0.025 μm, a 3D network structure is difficult to form in the matrix 1. Moreover, if the secondary particle diameter exceeds 2 μm, there are cases that the size (pore size) of the voids 1b in the solid framework 1a is overly large, which lowers the strength.

In this embodiment, a commercially available boehmite power containing aluminum oxyhydroxide (or alumina hydrate) can be used suitably. For example, Boehmite (trade name) produced by Taimei Chemicals Co., Ltd., Disperal HP15 (trade name) by CONDEA Corporation, Versal™ Alumina (trade name) by Union Showa K.K., Celasule (trade name) by Kawai Lime Industry Co., Ltd., CAM9010 (trade name) by TOMOE Engineering Co., Ltd., Aluminasol 520 (trade name) by Nissan Chemicals Industries, Ltd., Aluminasol-10A (trade name) by Kawaken Fine Chemicals Co., Ltd., SECO Boehmite Alumina (trade name) by SECO International Inc., and so on may be used.

The slurry containing boehmite powder is obtained by mixing boehmite powder with water or a polar solvent such as alcohol and adjusting the mixed solution to be acidic. In method (I), a metal compound as the raw material of the metal fine-particles 3 is added in the slurry and evenly mixed to prepare a coating liquid.

When the slurry is prepared by dispersing boehmite powder in water or a polar organic solvent, the amount of the used boehmite powder is preferably 5 to 40 weight parts, and more preferably 10 to 25 weight parts, relative to 100 weight parts of the solvent. The used solvent is exemplified by water, methanol, ethanol, glycerin, N,N-dimethylformamide, N,N-dimethylacetoamide (DMAc), N-methyl-2-pyrrolidone, and so on. These solvents can be used alone or in combination of two or more. The mixed solution is desirably subjected to a dispersion treatment to improve the dispersity of the boehmite powder. The dispersion treatment can be carried out based on, e.g., a method of stirring at room temperature for 5 or more minutes, or a method using an ultrasonic wave.

If required, the pH of the mixed solution is adjusted to 5 or less such that the boehmite powder is evenly dispersed. In such cases, as the pH adjuster, for example, organic acids such as formic acid, acetic acid, glycolic acid, oxalic acid, propionic acid, malonic acid, succinic acid, adipic acid, maleic acid, malic acid, tartaric acid, citric acid, benzoic acid, phthalic acid, isophthalic acid, terephthalic acid, glutaric acid, gluconic acid, lactic acid, aspartic acid, glutamic acid, pimelic acid, suberic acid and so on, inorganic acids such as hydrochloric acid, nitric acid, phosphoric acid and so on, and salts of these acids may be added suitably. Moreover, the pH adjusters may be used alone or in combination of two or more. Though the particle diameter distribution of the boehmite powder is changed by the addition of pH adjuster as compared with the cases without addition of a pH adjuster, there is no particular problem.

In method (I), a metal compound as the raw material of the metal fine-particles 3 is further added in the above-prepared slurry to obtain a coating liquid. In this step, the metal compound is added in an amount such that the metal element takes 7.5 to 480 weight parts relative to 100 weight parts of the solid content of the slurry. Moreover, the viscosity of the coating liquid may be increased by adding the metal compound in the above-prepared slurry. In such cases, it is desired to properly add the above solvent to adjust the viscosity optimally.

As the metal compound contained in the coating liquid prepared in above method (I) or contained in the metal ion containing solution prepared in above method (II), a compound containing the above metal species constituting the metal fine-particles 3 can be used without particular limitation. As the metal compounds, salts, carbonyl complexes and so on of the above metals can be used. Examples of the salts are chlorides, sulfate salts, acetate salts, oxalate salts, citrate salts, and so on. The organic carbonyl compounds capable of forming organic carbonyl complexes with the above metal species can be exemplified by β-diketones such as acetylacetone, benzoylacetone and dibenzoylmethane, etc., β-ketocarboxylate esters such as ethyl acetoacetate, etc., and so on.

Preferred specific examples of the metal compound include H[AuCl₄], Na[AuCl₄], AuI, AuCl, AuCl₃, AuBr₃, NH₄[AuCl₄].nH₂O, Ag(CH₃COO), AgCl, AgClO₄, Ag₂CO₃, AgI, Ag₂SO₄, AgNO₃, Ni(CH₃COO)₂, Cu(CH₃COO)₂, CuSO₄, CuSO₄, CuSO₄, CuCl₂, CuSO₄, CuBr₂, Cu(NH₄)₂Cl₄, CuI, Cu(NO₃)₂, Cu(CH₃COCH₂COCH₃)₂, CoCl₂, CoCO₃, CoSO₄, Co(NO₃)₂, NiSO₄, NiCO₃, NiCl₂, NiBr₂, Ni(NO₃)₂, NiC₂O₄, Ni(H₂PO₂)₂, Ni(CH₃COCH₂COCH₃)₂, Pd(CH₃COO)₂, PdSO₄, PdCO₃, PdCl₂, PdBr₂, Pd(NO₃)₂, Pd(CH₃COCH₂COCH₃)₂, SnCl₂, IrCl₃, RhCl₃, and so on.

In order to improve the strength, transparency, glossiness and so on of the matrix 1, as required, it is possible to mix a binder component in the prepared slurry or coating liquid. The binder component preferably can be used in combination with the aluminum oxyhydroxide. Examples thereof include: gum Arabic; cellulose derivatives, such as carboxymethylcellulose and hydroxyethylcellulose, etc.; vinyl copolymer latex, such as SBR latex, NBR latex, functional group modified polymer latex, and ethylene-vinyl acetate copolymer, etc.; water-soluble cellulose; polyvinylpyrrolidone; gelatin and its modified products; starch and its modified products; casein and its modified products; maleic anhydride and its copolymers; acrylate ester copolymers; polyacrylic acid and its copolymers; polyamic acid (precursor of polyimide); and silane compounds, such as tetraethoxysilane, tetramethoxysilane, methyltrimethoxysilane, methyltriethoxysilane, dimethyldiethoxysilane, phenyltriethoxysilane, hexamethyldisilazane, hexyltrimethoxysilane, decyltrimethoxysilane, n-octyltriethoxysilane, 3-aminopropyltriethoxysilane, 3-aminopropyltrimethoxysilane, N-2-(aminoethyl)-3-aminopropyltrimethoxysilane, N-2-(aminoethyl)-3-aminopropyltriethoxysilane, N-2-(aminoethyl)-3-aminopropylmethyldimethoxysilane, 3-tri ethoxysilyl-N-(1,3-dimethylbutylidene)propyl amine, N-phenyl-3-aminopropyltrimethoxysilane, N-(vinylbenzyl)-2-aminoethyl-3-aminopropyltrimethoxysilane chloride, vinyltrichlorosilane, vinyltrimethoxysilane, vinyltriethoxysilane, vinyltris(2-methoxyethoxy)silane, vinylmethyldimethoxysilane, 2-(3,4-epoxycyclohexyl)ethyltrimethoxysilane, 3-glycidoxypropyltrimethoxysilane, 3-glycidoxypropylmethyldiethoxysilane, 3-glycidoxypropyltriethoxysilane, p-styryltrimethoxysilane, 3-methacryloxypropylmethyldimethoxysilane, 3-methacryloxypropyltrimethoxysilane, 3-methacryloxypropylmethyldiethoxysilane, 3-methacryloxypropyltriethoxysilane, 3-acryloxypropyltrimethoxysilane, 3-ureidopropyltriethoxysilane, 3-chloropropyltrimethoxysilane, 3-mercaptopropylmethyldimethoxysilane, 3-mercaptopropyltrimethoxysilane, bis(triethoxysilylpropyl)tetrasulfide, 3-isocyanatopropyltriethoxysilane and 3-isocyanatopropyltrimethoxysilane, etc.; and so on. These binder components can be used alone or in combination of two or more. The binder component can be added suitably, and the added amount is preferably 1 to 200 weight parts and more preferably 5 to 100 weight parts relative to 100 weight parts of the solid content of the slurry.

Among the above binder materials, the silane compounds with a coupling effect are preferably used in order to improve the strength of the matrix 1. The addition amount of the silane compound is preferably 1 to 200 weight parts, more preferably 5 to 100 weight parts and even more preferably 10 to 80 weight parts relative to 100 weight parts of the solid content of the slurry. By adding the silane in such amount, the pencil hardness of the solid framework 1a of the matrix 1 can be increased to, for example, 6H or higher. Particularly, in method (II), because the reduction treatment is carried out after the matrix 1 is formed and impregnated with the solution containing the metal ion, the hardness of the solid framework 1a of the matrix 1 can be sufficiently increased by adding a large amount of the binder such as the silane compound. That is, by adopting the impregnation method, even when the binder is added in a high concentration (e.g., 30 weight parts relative to 100 weight parts of the solid content of the slurry), there is not a concern that the surface of the metal fine-particle 3 will be covered by the binder. Hence, by adding the binder in a high concentration, the strength and durability of the matrix 1 can be improved without lowering the LSPR effect, and a sharp and stable scatter spectrum can be obtained.

In addition to the binder, if required, it is also possible to add, in the above slurry or coating liquid, a dispersant, a thickener, a lubricant, a flowability modifier, a surfactant, a defoaming agent, a water resistant agent, a releasing agent, a fluorescent brightening agent, a UV absorbent, and/or an anti-oxidant, etc., in a range not degrading the effects of this invention.

The method of coating the substrate with the coating liquid containing the metal compound or the slurry not containing the metal compound is not particularly limited. The coating can be carried out with, for example, a lip coater, a knife coater, a comma coater, a blade coater, an air knife coater, a roll coater, a curtain coater, a bar coater, a gravure coater, a die coater, a spin coater, or a spray, etc.

The substrate used in the coating is not particularly limited in cases where the nano-composite 10 will be peeled from the once-used substrate. In cases where the substrate used for forming the nano-composite 10 is directly utilized as the light transmission layer 20, the substrate includes the same material of the light transmission layer 20 described later.

After being coated on the substrate, the coating liquid containing the metal compound or the slurry not containing the metal compound is dried to form a coated film. The drying method is not particularly limited, and may be done, for example, at a temperature within the range of 60 to 150° C. for 1 to 60 minutes, preferably at a temperature within the range of 70 to 130° C.

After the coating liquid containing the metal compound or the slurry not containing the metal compound is coated and dried, a heating treatment is performed to form the matrix 1, preferably at a temperature of 150 to 700° C. and more preferably at a temperature of 170 to 600° C. When the temperature of the heating treatment is lower than 150° C., the 3D network structure of the solid framework 1a of the matrix 1 may not be easy to form, and, in method (I), a formation of the metal fine-particles 3 through heat-reduction of the metal ion may not be carried out sufficiently.

In above method (I), formation of the matrix 1, formation of the metal fine-particles 3 through the reduction of the metal ion, and dispersion of the metal fine-particles 3 can be carried out simultaneously in a single heating step.

In above method (II), the matrix 1 is impregnated with a solution containing a metal ion after being formed, and is heated to reduce the metal ion to form the metal fine-particles 3 and disperse the same. The metal ion containing solution used in the method (II) preferably contains the metal ion in an amount of 1 to 20 wt % in terms of the metal element. When the metal ion has a concentration within the above range, the amount of the metal element can be 7.5 to 480 weight parts relative to 100 weight parts of the solid content of the slurry. The impregnation method in above method (II) is not particularly limited as long as it allows at least the surface of the matrix 1 to contact with the metal ion containing solution, and can be a well-known method, such as dipping, spraying, brush application, or printing, etc. The impregnation temperature is 0 to 100° C., preferably a normal temperature around 20 to 40° C. Moreover, when the dipping method is used, the impregnation time is, e.g., 5 or more seconds desirably. The heating treatment for reducing the metal ion and dispersing the separated metal fine-particles 3 is done preferably at 150 to 700° C. and more preferably at 170 to 600° C. When the temperature of the heating treatment is lower than 150° C., the reduction of the metal ion is insufficient, and the mean particle diameter of the metal fine-particles 3 may be difficult to be equal to or greater than the aforementioned lower limit (3 nm). Moreover, when the temperature of the heating treatment is lower than 150° C., the thermal diffusion of the reduction-separated metal fine-particles 3 in the matrix 1 may be insufficient.

Formation of the metal fine-particles 3 by heating reduction is described below. The particle diameter D and the inter-particle distance L can be controlled by the heating temperature and the heating time in the heating step, the content of the metal ion contained in the matrix 1, and so on. The inventors have discovered that when the heating temperature and the heating time in the heating step are constants but the absolute amount of the metal ion contained in the matrix 1 is varied, the particle diameter D of the separated metal fine-particles 3 is varied. The inventors have also discovered that when the heating reduction is performed without controlling the heating temperature and heating time, the inter-particle distance L is smaller than the particle diameter D_{L} of the larger one of neighboring metal fine-particles 3.

Moreover, based on the above discoveries, for example, the thermal treatment in the reduction step can be conducted in multiple stages. For example, it is possible to conduct a particle-diameter controlling step in which the metal fine-particles 3 grow to a predetermined particle diameter D at a first heating temperature, and an inter-particle distance controlling step that maintains the inter-particle distance L of the metal fine-particles 3 in a predetermined range at a second heating temperature being the same as or different from the first heating temperature. In this way, by adjusting the first and the second heating temperatures and the heating time, the particle diameter D and the inter-particle distance L can be controlled more precisely.

The reasons that heating reduction is adopted as the reduction method include industrial merits, such as, that the particle diameter D and the inter-particle distance L can be controlled more easily by adjusting the treatment condition (especially the heating temperature and the heating time), that such method can be coped with a simple equipment without a particular limitation from the lab scale to the production scale, and that such method can be performed in a single-piece manner or a continuous manner without special efforts, etc. The thermal reduction can be conducted, for example, in an atmosphere of an inert gas such as Ar or N₂ etc., in a vacuum of 1 to 5 kPa, or in the atmosphere. It is also possible to utilize a vapor reduction method using a reductive gas such as H₂ gas.

In the thermal reduction step, the metal ion existing in the matrix 1 is reduced, and respective metal fine-particles 3 can be independently separated due to thermal diffusion. Such formed metal fine-particles 3 are in a state that the inter-particle distance L is kept equal to or larger than a predetermined value, and also have an approximately uniform shape, while the metal fine-particles 3 are not unevenly 3D-dispersed in the matrix resin 1. Particularly, when this thermal reduction step is utilized for reduction, the nano-composite layer 10 can be obtained with the shapes and the particle diameters of the metal fine-particles 3 being uniformized and with the metal fine-particles 3 being evenly separated and dispersed in the matrix 1 in an appropriately uniform inter-particle distance L. Moreover, by controlling the constituent unit of the inorganic oxide constituting the matrix 1 or controlling the absolute amount of the metal ion and the volume fraction of the metal fine-particles 3, the particle diameter D of the metal fine-particles 3 and the distribution state of the metal fine-particles 3 in the matrix 1 can be controlled.

Moreover, by having a polyvinylalcohol co-exist with the metal ion in the thermal reduction step, the particle diameter D of the metal fine-particles 3 can be inhibited to be small, and formation of aggregated particles can be prevented even when the amount of the metal ion in the coated film is large. This is considered to be due to the following reason. In the thermal reduction of the metal ion, the polyvinylalcohol having multiple —OH groups becomes an electron donor and hence functions as a reduction assistant to promote the reduction of the metal ion, so that more metal nuclei are formed as compared to a case without using a polyvinylalcohol and independently grow to form the metal fine-particles 3. Moreover, due to the effect of using the polyvinylalcohol, the metal fine-particles 3 formed from thermal reduction of the metal ion are not enlarged even when the temperature of the heating treatment is high (e.g., within the range of 450 to 600° C.), and the metal fine-particles can be dispersed well. Hence, by adding a polyvinylalcohol as a reduction assistant, the scatter spectrum of the LSPR of the nano-composite layer 10 is sharpened, and a high-precision detection is possible when the nano-composite layer 10 is used in various sensing devices. In order to develop such a function, the polyvinylalcohol preferably exists in proximity to the formed metal fine-particles. Hence, it is good that the polyvinylalcohol and the metal ion are in a fully mixed state, and it is advantageous to add the polyvinylalcohol in the metal compound-containing coating liquid of method (I) or the metal ion-containing solution of method (II) to create a mixed state. Moreover, although the polyvinylalcohol will gasify and vanish by heating to a temperature equal to or higher than the thermal decomposition temperature thereof after the reduction treatment, multiple voids are formed as traces of the polyvinylalcohol in proximity with the metal fine-particles because the polyvinylalcohol is added in the metal compound-containing coating liquid or metal ion-containing solution to form a fully mixed state. Because the voids ensure an exposure space for the metal fine-particles, the optical properties from the LSPR change remarkably to the change of the ambient environment, and the effect of the sensing characteristic is improved. Moreover, it is clear from the above-mentioned effect of the polyvinylalcohol that in this embodiment, the polyvinylalcohol does not function as a binder enforcing the solid framework 1a of the matrix 1.

The polyvinylalcohol may be added before the heating treatment of the step Id or IId. In method (I), the polyvinylalcohol is preferably added in, for example, the step Ia of preparing the slurry, or the step Ib of preparing the coating liquid. In method (II), the polyvinylalcohol can be added at any stage before the thermal reduction treatment of the step IId, for example, the stage of preparing the metal ion-containing solution in the step of impregnation with the metal ion-containing solution. Because polyvinylalcohol is a water-soluble polymer, it can be easily mixed in the above slurry or coating liquid after being dissolved in water. Moreover, after the polyvinylalcohol is added, it is preferred to evenly stir the above slurry or the coating liquid.

The polymerization degree of the polyvinylalcohol used as a reduction assistant is preferably 10 to 5000 and more preferably 50 to 3000. Moreover, the molecular weight of the polyvinylalcohol is preferably 440 to 220000 and more preferably 2200 to 132000. If the polymerization degree or molecular weight of the polyvinylalcohol is smaller than the above lower limit, when the nano-composite is fabricated by heating, the polyvinylalcohol may be evaporated before functioning as a reduction assistant. If the polymerization degree or molecular weight of the polyvinylalcohol is larger than the above upper limit, the polyvinylalcohol has a remarkably low solubility and may be difficult to be added and mixed in the slurry or the coating liquid.

Moreover, because the —OH groups formed through the saponification effect the reduction of the metal ion, the saponification degree of the polyvinylalcohol is preferably higher, e.g., up to 30% or more, and more preferably 50% or more.

In the reduction reaction, because one —OH group of the polyvinylalcohol can provide two electrons, corresponding to the added amount of the metal compound, the amount of the polyvinylalcohol required for the function of being a reduction assistant of the metal ion can be roughly determined. For example, the reduction of one Au ion of chloroauric acid tetrahydrate requires three electrons. Because one —OH group of the polyvinylalcohol can provide two electrons, on calculation, 3/2 mole of —OH groups of polyvinylalcohol is required for one mole of chloroauric acid tetrahydrate molecule. Accordingly, the required weight ratio (on calculation) of the used polyvinylalcohol to the metal compound can be obtained. However, because the —OH groups of the polyvinylalcohol are not only used for the reduction but also thermally decomposed, the polyvinylalcohol is preferably added in an excess amount relative to the above-calculated weight ratio. On the other hand, if the amount of the added polyvinylalcohol is overly larger than the above-calculated weight ratio, a large amount of the polyvinylalcohol will remain in the nano-composite layer 10, and there are concerns that certain inconveniences, such as a large amount of excess exhaust gas from the composition of the polyvinylalcohol, may occur. Because of these issues, the amount of the added polyvinylalcohol functioning as a reduction assistant also depends on the saponification degree of the polyvinylalcohol. For example, when the saponification degree of the polyvinylalcohol is 88%, the amount of the added polyvinylalcohol is preferably 0.1 to 50 weight parts and more preferably 0.15 to 20 weight parts relative to 1 weight part of the metal compound.

The method for fabricating the nano-composite of this embodiment may also include any step other than the above steps. For example, when the polyvinylalcohol is added as a reduction assistant, a step of thermally treating the nano-composite layer at a temperature equal to or higher than the start temperature of thermal decomposition of the polyvinylalcohol may also be included. By heating the nano-composite layer 10 again, the polyvinylalcohol-originated organic substances (called “polyvinylalcohol-originated components”, hereinafter) remaining in the nano-composite layer 10 can be thermally decomposed/gasified and removed. In cases where the nano-composite is applied to sensors utilizing LSPR, because the polyvinylalcohol-originated components remaining in the nano-composite layer 10 is a cause of lowering the detection sensitivity, they are preferably removed. Because the starting temperature of the thermal decomposition of the polyvinylalcohol-originated components is around 200° C., the nano-composite layer 10 is heated to a temperature of 200° C. or more, preferably 300° C. or more, and more preferably 450° C. or more at which the polyvinylalcohol-originated components can be decomposed almost completely. The thermal treatment is preferably within the temperature range that does not have affects such as decomposition or melting of the solid framework 1a and metal fine-particles 3 that constitute the nano-composite layer 10, and the upper limit of the thermal treatment temperature may be 600° C. or lower. Here, the so-called polyvinylalcohol-originated components include the polyvinylalcohol not consumed as the reduction assist, for example, a modification product or decomposition product of the polyvinylalcohol caused by oxidation and so on (for example, conversion of the alcohol moiety to ketone) that change the structure of the polyvinylalcohol in the thermal treatment.

Moreover, the thermal treatment can be performed simultaneously with the heating treatment in the step Id or IId. That is, by performing the thermal treatment and the heating treatment simultaneously in one step, at the same time the metal ion of the metal compound is thermally reduced to separate particle-like metal as the metal fine-particles 3, the polyvinylalcohol-originated components are decomposed/gasified and removed. Herein, the lower limit of the temperature of the heating treatment is preferably 200° C. or higher and more preferably 300° C. or higher, and the upper limit of the temperature of the heating treatment is preferably 600° C. or lower and more preferably 550° C. or lower.

With the above steps, the nano-composite layer 10 can be fabricated. Moreover, in cases where a metal hydroxide other than boehmite or a metal oxide is used as the matrix 1, the nano-composite layer can also be made according to the above method.

### <Alternative Embodiment of Nano-Composite Layer>

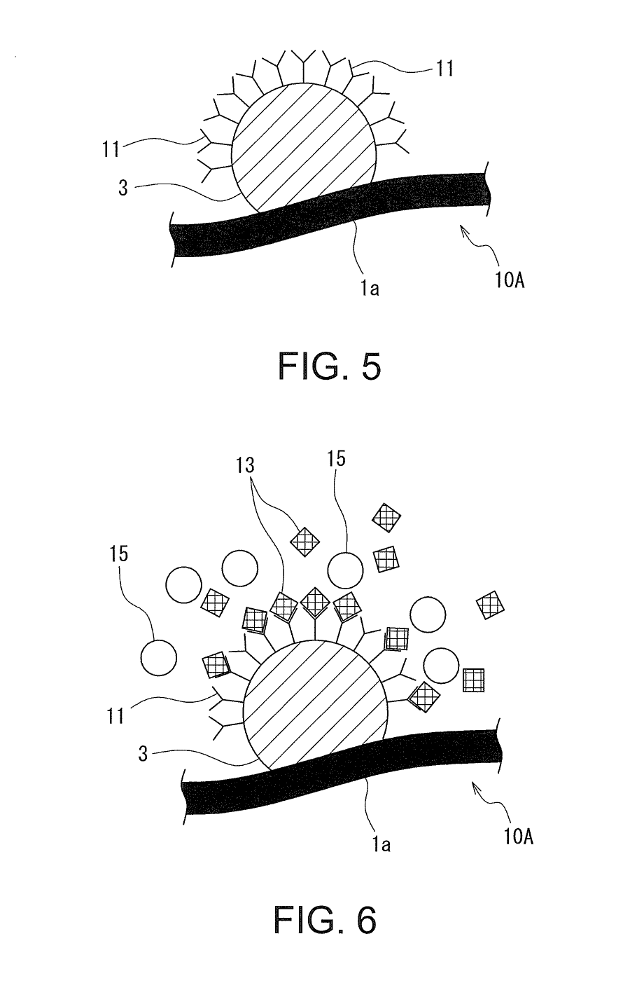

Next, an alternative embodiment of the nano-composite layer possibly used in the composite substrate 100 is described. In a preferred embodiment of this invention, as shown in the magnified illustration of FIG. 5, a binding species 11 can be immobilized on the surface of the metal fine-particle 3. The binding species 7 in the nano-composite 10A of this alternative embodiment can be defined as, for example, a substance that has a functional group X capable of bonding with the metal fine-particle 3 and a functional group Y interacting with a specific substance such as the detection-object molecule. The binding species 11 is not limited to a single molecule, and also covers, for example, a composite constituted of two or more components, etc. The binding species 11 is bonded with the metal fine-particle 3 via the functional group X and immobilized on the surface of the same. In such a case, the bonding between the functional group X and the metal fine-particles 3 indicates, e.g., chemical bonding, or physical bonding through adsorption or the like, etc. Moreover, the interaction between the functional group Y and the specific substance means, for example, a chemical bonding, or a physical bonding such as adsorption and so on, and may alternatively mean that the functional group Y is partially or entirely altered (modified or removed, etc.), and so on.

The functional group X of the binding species 11 is a functional group immobilized on the surfaces of the metal fine-particles 3, which may be immobilized by chemically bonding to the surfaces of the metal fine-particles, or be immobilized through adsorption. Examples of such functional group X include monovalent groups such as —SH, —NH₂, —NH₃X (X is a halogen atom), —COOH, —Si(OCH₃)₃, —Si(OC₂H₅)₃, —SiCl₃ and —SCOCH₃, etc., and divalent groups such as —S₂— and —S₄—, etc. The preferred groups among them are those containing one or more sulfur atoms, such as the mercapto group, the sulfide group and the disulfide group, etc.

Moreover, the functional group Y of the binding species 11 may be, for example, a substituent capable of bonding with a metal, an inorganic compound such as a metal oxide, or an organic compound such as DNA or protein, or alternatively, a leaving group that may leave due to, for example, an acid or an alkali, etc. Examples of the functional group Y allowing such interaction include —SH, —NH₂, —NR₃X (R is a hydrogen atom or a C₁-C₆ alkyl group, and X is a halogen atom), —COOR (R is a hydrogen atom or a C₁-C₆ alkyl group), —Si(OR)₃ (R is a C₁-C₆ alkyl group), SiX₃ (X is a halogen atom), —SCOR (R is a C₁-C₆ alkyl group), —OH, —CONH₂, —N₃, —CR═CHR′ (R and R′ are each independently a hydrogen atom or a C₁-C₆ alkyl group), —C≡CR (R is a hydrogen atom or a C₁-C₆ alkyl group), —PO(OH)₂, —COR (R is a C₁-C₆ alkyl group), imidazolyl, hydroquinolyl, —SO₃⁻X (X is an alkali metal), N-hydroxysuccinimide group (—NHS), a Biotin group, —SO₂CH₂CH₂X (X is a halogen atom, —OSO₂CH₃, —OSO₂C₆H₄CH₃, —OCOCH₃, —SO₃⁻, or pyridium), etc.

Specific examples of the binding species 11 include: HS—(CH₂)ₙ—OH (n=11 or 16), HS—(CH₂)ₙ—COOH (n=10, 11 or 15), HS—(CH₂)ₙ—COO—NHS (n=10, 11 or 15), HS—(CH₂)ₙ—NH₂.HCl (n=10, 11 or 16), HS—(CH₂)₁₁—NHCO-Biotin, HS—(CH₂)₁₁—N(CH₃)₃⁺Cl⁻, HS—(CH₂)ₙ—SO₃⁻Na⁺(n=10, 11, or 16), HS—(CH₂)₁₁—PO(OH)₂, HS—(CH₂)₁₀—CH(OH)—CH₃, HS—(CH₂)₁₀—COCH₃, HS—(CH₂)ₙ—N₃ (n=10, 11, 12, 16 or 17), HS—(CH₂)ₙ—CH═CH₂ (n=9 or 15), HS—(CH₂)₄—C≡CH, HS—(CH₂)ₙ—CONH₂ (n=10 or 15), HS—(CH₂)₁₁—(OCH₂CH₂)ₙ—OCH₂—CONH₂ (n=3 or 6), HO—(CH₂)₁₁—S—S—(CH₂)₁₁—OH, and CH₃—CO—S—(CH₂)₁₁—(OCH₂CH₂)ₙ—OH (n=3 or 6).

Other examples of the binding species 11 include: heterocyclic compounds having an amino group or a mercapto group, such as 2-amino-1,3,5-triazine-4,6-dithiol, 3-amino-1,2,4-triazole-5-thiol, 2-amino-5-trifluoromethyl-1,3,4-thiadiazole, 5-amino-2-mercaptobenzimidazole, 6-amino-2-mercaptobenzothiazole, 4-amino-6-mercaptopyrazolo[3,4-d]pyrimidine, 2-amino-4-methoxybenzothiazole, 2-amino-4-phenyl-5-tetradecylthiazole, 2-amino-5-phenyl-1,3,4-thiadiazole, 2-amino-4-phenylthiazole, 4-amino-5-phenyl-4H-1,2,4-triazole-3-thiol, 2-amino-6-(methylsulfonyl)benzothiazole, 2-amino-4-methylthiazole, 2-amino-5-(methylthio)-1,3,4-thiadiazole, 3-amino-5-methylthio-1H-1,2,4-thiazole, 6-amino-1-methyluracil, 3-amino-5-nitrobenzisothiazole, 2-amino-1,3,4-thiadiazole, 5-amino-1,3,4-thiadiazole-2-thiol, 2-aminothiazole, 2-amino-4-thiazoleacetic acid, 2-amino-2-thiazoline, 2-amino-6-thiocyanatobenzothiazole, DL-α-amino-2-thiopheneacetic acid, 4-amino-6-hydroxy-2-mercaptopyrimidine, 2-amino-6-purinethiol, 4-amino-5-(4-pyridyl)-4H-1,2,4-triazole-3-thiol, N⁴-(2-amino-4-pyrimidinyl)sulfanylamide, 3-aminorhodanine, 5-amino-3-methylisothiazole, 2-amino-α-(methoxyimino)-4-thiazoleacetic acid, thioguanine, 5-amino-tetrazole, 3-amino-1,2,4-triazine, 3-amino-1,2,4-triazole, 4-amino-4H-1,2,4-triazole, 2-aminopurine, aminopyrazine, 3-amino-2-pyrazinecarboxylic acid, 3-aminopyrazole, 3-aminopyrazole-4-carbonitrile, 3-amino-4-pyrazolecarboxylic acid, 4-aminopyrazolo[3,4-d]pyrimidine, 2-aminopyridine, 3-aminopyridine, 4-aminopyridine, 5-amino-2-pyridinecarbonitrile, 2-amino-3-pyridinecarboxaldehyde, 2-amino-5-(4-pyridinyl)-1,3,4-thiadiazole, 2-aminopyrimidine, 4-aminopyrimidine, and 4-amino-5-pyrimidinecarbonitrile, etc; and silane coupling agents having an amino group or a mercapto group, such as 3-aminopropyltriethoxysilane, 3-aminopropyltrimethoxysilane, N-2-(aminoethyl)-3-aminopropyltrimethoxysilane, N-2-(aminoethyl)-3-aminopropylmethyldimethoxysilane, 3-triethoxysilyl-N-(1,3-dimethylbutylidene)propylamine, N-phenyl-3-aminopropyltrimethoxysilane, 3-mercaptopropyltriethoxysilane, 3-mercaptopropyltrimethoxysilane, N-2-(mercaptoethyl)-3-mercaptopropyltrimethoxysilane, N-2-(mercaptoethyl)-3-mercaptopropylmethyldimethoxysilane, 3-triethoxysilyl-N-(1,3-dimethylbutylidene)propylmercapto, and N-phenyl-3-mercaptopropyltrimethoxysilane, etc. Moreover, the binding species 11 is not particularly limited to the above compounds, and the binding species 11 may include the above compounds alone or in combination of two or more thereof.

Moreover, the molecular skeleton of the binding species 11 between the functional groups X and Y includes atoms selected from the group consisting of carbon, oxygen and nitrogen atoms, and may have, e.g., a straight or branched chemical structure with a straight moiety of C₂-C₂₀, preferably C₂-C₁₅ and more preferably C₂-C₁₀, or a cyclic chemical structure. The molecular skeleton may be designed using a single molecule species, or alternatively using two or more molecule species. In an example of suitably applied embodiments where, for example, a detection-object molecule or the like is to be effectively detected, it is preferred that the thickness of the molecular mono-film (or molecular monolayer) formed by the binding species 11 is in the range of about 1.3 nm to 3 nm. In view of this, a binding species 11 having a C₁₁-C₂₀ alkane chain as a molecular skeleton is preferred. In such a case, for the long alkane chain immobilized on the surface of the metal fine-particle 3 via the functional group X extends vertically from the surface to form a molecular mono-film (molecular monolayer), the functional group Y suffuses the surface of the molecular mono-film (molecular monolayer). Well-known thiol compounds useful as reagents for forming self-assembly mono-films (SAM) can be suitably used as such binding species 11.

The nano-composite layer 10A with the above constitution can be used as, for example, an affinity sensor. FIG. 6 is a schematic illustration of application of the nano-composite 10A as an affinity sensor. At first, a nano-composite 10A is provided, which has a structure where the binding species 11 (ligand) is bonded to the exposed portions (the portions exposed in the voids 1b) of the metal fine-particles 3 immobilized in the solid framework. Next, a sample containing an analyte 13 and a non-detection object substance 15 is made contact with the nano-composite 10A having the binding species 11 being bonded to the metal fine-particles 3. Because the binding species 11 has a specific bindability with the analyte 13, a specific binding is produced between the analyte 13 and the binding species 11 through the contact. The non-detection object substance 15, which has no specific bindability with the binding species 11, does not bind with the binding species 11. As compared with the nano-composite 10 to which no analyte 10 but only the binding species 11 is bonded, the nano-composite 10A to which the analyte 13 is bonded via the binding species 11 has a change in the absorption spectrum of the LSPR, under light irradiation. That is, the developed color is changed. In this way, by detecting a change in the absorption spectrum of the LSPR, the analyte 13 in the sample can be detected with high sensitivity. The affinity sensors utilizing LSPR does not need to use a label substance, and can be utilized as a technique for sensors with simple constitutions in various fields, such as bio-sensors, gas sensors, chemical sensors, and so on.

### <Fabrication Method>

Next, the method of fabricating the nano-composite 10A of this alternative embodiment is described, which may be the following method (I′) derived from above method (I) or the following method (II′) derived from above method (II).

Method (I′) has the same steps Ia to Id of the above method (I) that may use a polyvinylalcohol as a reduction assistant, and, after the step Id, a step Ie that immobilizes the species 11 on the surface of the metal fine-particles 3.

Method (II′) has the same steps IIa to IId of the above method (II) that may use a polyvinylalcohol as a reduction assistant, and, after the step IId, a step He that immobilizes the species 11 on the surface of the metal fine-particles 3.

Because the steps Ia to Id of method (I′) and the steps IIa to IId of method (II′) have been described in the above descriptions for methods (I) and (II), they are not repeated again. The step Ie or IIe is a step of immobilizing the binding species by adding the same onto the metal fine-particles 3 of the nano-composite layer 10 to obtain the nano-composite layer A, and can be performed as follows.

Step of Immobilizing the Binding Species:

In the step of immobilizing the binding species 7, the binding species 7 is immobilized on the surfaces of the exposed portions of the metal fine-particles 3. The step of immobilizing the binding species 11 can be conducted by making the same contact with the surfaces of the exposed portions of the metal fine-particles 3. For example, it is preferred to conduct a surface treatment of the metal fine-particles 3 using a treating liquid obtained by dissolving the binding species 11 in a solvent. The solvent for dissolving the binding species 11 can use, but is not limited thereto, water, C₁-C₈ hydrocarbon alcohols such as methanol, ethanol, propanol, isopropanol, butanol, t-butanol, pentanol, hexanol, heptanol and octanol, etc., C₃-C₆ hydrocarbon ketones such as acetone, propanone, methylethyl ketone, pentanone, hexanone, methylisobutyl ketone and cyclohexanone, etc., C₄-C₁₂ hydrocarbon ethers such as diethylether, ethylene glycol dimethylether, diethylene glycol dimethylether, diethylene glycol diethylether, diethylene glycol dibutylether and tetrahydrofuran, etc., C₃-C₇ hydrocarbon esters such as methyl acetate, ethyl acetate, propyl acetate, butyl acetate, γ-butyrolactone and diethyl malonate, etc., C₃-C₆ amides such as dimethylformamide, dimethylacetoamide, tetramethylurea and hexamethylphosphoric triamide, etc., C₂ sulfoxides such as dimethylsulfoxide, etc., C₁-C₆ halogen-containing compounds such as chloromethane, bromomethane, dichloromethane, chloroform, carbon tetrachloride, dichloroethane, 1,2-dichloroethane, 1,4-dichlorobutane, trichloroethane, chlorobenzene and o-dichlorobenzene, etc., and C₄-C₈ hydrocarbon compounds such as butane, hexane, heptane, octane, benzene, toluene and xylene, etc.

The concentration of the binding species 11 in the treating liquid is preferably from 0.0001 M (mol/L) to 1 M, for example. Although a low concentration leads to a merit that a small amount of remaining binding species 11 is bonded to the surfaces of the metal fine-particles 3, the concentration is more preferably from 0.005 M to 0.05 M.

In a case where the surfaces of the metal fine-particles 3 are to be treated by the above treating liquid, the treatment method is not limited as long as the treating liquid can contact the exposed portions of the metal fine-particles 3, while a uniform contact is preferred. For example, the nano-composite layer 10 having the metal fine-particles 3 may be immersed in the treating liquid, or the treating liquid may be sprinkled to the exposed portions of the metal fine-particles 3 in the nano-composite layer 10 by spraying, etc. Moreover, the temperature of the treating liquid at this moment is not particularly limited, and may be within the range of −20° C. to 50° C. Moreover, when the surface treatment adopts the immersion method, for example, the immersion time is preferably from 1 min to 24 hours.

After the surface treatment is finished, it is preferred to conduct a cleaning step that uses an organic solvent to dissolve and remove the excess binding species 11 adhering to the surfaces of the metal fine-particles 3. The organic solvent used in the cleaning step can be one capable of dissolving the binding species 11. Examples of the solvents can be the above exemplified solvents for dissolving the binding species 11.

In the cleaning step, the method of cleaning the surfaces of the metal fine-particles 3 by the organic solvent is not limited. It is possible to immerse the metal fine-particles 3 in the organic solvent, or to sprinkle the organic solvent by spraying, etc., to flush the metal fine-particles 3. In this cleaning step, though the excess binding species 11 adhering to the surfaces of the metal fine-particles 3 is dissolved and removed, the binding species 11 is not entirely removed. It is advantageous that the binding species 11 is removed by the cleaning to an extent that the film of the binding species 11 on the surfaces of the metal fine-particles 3 has approximately the thickness of a molecular mono-film. In a method to achieve this, a water cleaning step is conducted before the above cleaning step, the above cleaning step is conducted, and then another water cleaning step is conducted. The temperature of the organic solvent in the above cleaning step at this moment is preferably from 0° C. to 100° C. and more preferably in the range of 5-50° C. Moreover, the cleaning time is preferably from 1 sec to 1000 sec and more preferably in the range of 3 sec to 600 sec. The amount of the organic solvent used is preferably from 1 L to 500 L, more preferably in the range of 200 L to 400 L, per 1 m² of the surface area of the nano-composite 10.

Moreover, if required, it is preferred to remove the binding species 11 adhering to the surface of the solid framework 1a by an alkali solution. The alkali solution used at this moment preferably has a concentration from 10 mM (mmol/L) to 500 mM and a temperature from 0° C. to 50° C. When the alkali solution is used for immersion, for example, the immersion time is preferably from 5 sec to 3 min.

With the above steps, the nano-composite layer 10 or 10A used in the composite substrate 100 can be fabricated.

<Light Transmission Layer>

The light transmission layer 20 used in the composite substrate 100 can be formed from a material transparent to light having a wavelength causing LSPR, e.g., 300 to 900 nm in cases where the metal fine-particle 3 is made from gold or silver. Examples of such materials include: inorganic transparent substrates such as glass and quartz, transparent conductive materials such as indium tin oxide (ITO) and zinc oxide, and transparent synthetic resins such as polyimide resin, PET resin, acryl resin, MS resin, MBS resin, ABS resin, polycarbonate resin, silicone resin, siloxane resin, and epoxy resin, etc.

In the composite substrate 100, the thickness T of the nano-composite layer 10 or 10A is preferably 0.5 to 5 μm, in view of improving the detection sensitivity of LSPR. If the thickness is less than 0.5 μm, the amount of the contained metal fine-particles is reduced and the particle diameter of the metal fine-particles becomes small, so that scatter light from LSPR is obtained insufficiently. On the other hand, when the thickness T exceeds 5 μm, the transparency to light is poor, and the diffusivity of the sample (gas or liquid) in the nano-composite layer 10 or 10A is lowered, so the detection sensitivity becomes low. Moreover, the thickness of the light transmission layer 20 is not particularly limited, and may be in the range of 1 μm to 10 mm.

With the above constitutions, the composite substrate 100 can well induce LSPR. The light emitted from an outer light source is incident in the nano-composite layer 10 or 10A to produce scattered light from LSPR. The scattered light is detected with the light receiving part (not shown), and the intensity or peak shift of the scatter spectrum is measured. By utilizing the scattered light from the nano-composite layer 10 or 10A in this way, the entire apparatus can be miniaturized, and also the dose of the irradiation light required to obtain LSPR absorption of the same intensity can be reduced, so that a high-sensitivity measurement can be realized under low power consumption.

<Method for Fabricating Composite Substrate>

The composite substrate 100 can be fabricated as follows, for example. In the first method, the substrate used in the fabrication process of the nano-composite layer 10 or 10A is directly used as the light transmission layer 20. An example is described below. The surface of the substrate serving as the light transmission layer 20 is coated with the coating liquid formed by mixing the slurry for forming the solid framework 1a and the metal compound, or the surface of the substrate serving as the light transmission layer 20 is coated with the slurry for forming the solid framework 1a and then the solid framework 1a is formed and impregnated with the metal ion-containing solution. Thereafter, a thermal treatment is performed to form the matrix 1 having the solid framework 1a and voids 1b and also to separate the metal fine-particles 3. By using such light transmission layer 20 as the substrate, the composite substrate 10 can be made with the same steps for fabricating the nano-composite layer 10 or 10A.

In the second method for fabricating the composite substrate 100, the nano-composite layer 10 or 10A and the light transmission layer 20 are fabricated respectively, and then the nano-composite layer 10 or 10A is piled on and fixed onto the surface of the light transmission layer 20. The nano-composite layer 10 or 10A and the light transmission layer 20 can be fixed in a manner such that the occurrence of LSPR is not influenced. For example, the nano-composite layer 10 or 10A may be fixed at its edge portion by an arbitrary means, such as adhesion through an adhesive or press-bonding, etc.

Moreover, the composite substrate 100 may also include a light source or a light receiving part as a constituent part thereof. In such cases, the light source may be a light source (not shown) that emits light having a wavelength (e.g., 300 to 900 nm in cases where the metal fine-particle 3 is made from gold or silver) inducing LSPR of the nano-composite layer 10 or 10A, and the light receiving part may be a light receiving part (not shown) that receives the scattered light produced by the nano-composite layer 10 or 10A. Moreover, when the light source and the light receiving part are arranged in an integral, the scattered light may be concentrated by a light-concentrating means such as a lens. When the light source and the light receiving part are arranged separately, it is possible that the light is incident to the composite substrate 100 in an arbitrary angle and the resulting scattered light is received by the light receiving part.

In the composite substrate 100 of this embodiment with the above constitutions, the nano-composite layer 10 or 10A has a configuration that the metal fine-particles 3 are 3D-dispersed evenly while maintaining an inter-particle distance L in the matrix 1 having a 3D network structure. Therefore, the scatter spectrum of the LSPR is sharp and very stable, so the reproducibility and the reliability are good. Moreover, because portions of the surfaces of the metal fine-particles 3 are exposed in the voids in the matrix 1 that communicate with the outer space, the characteristic that the resonance wavelength of the metal fine-particles 3 changes in response to the change of the dielectric constant (refractive index) of the ambient medium of the metal fine-particles 3 can be sufficiently displayed. Therefore, the composite substrate 100 is suitable for various sensing devices, such as bio-sensors, chemical sensors, humidity sensors, frost sensors, gas sensors, and so on. By applying the composite substrate 100 to the sensing devices, a high-precision detection is possible with a simple constitution.

[LSPR Sensor]

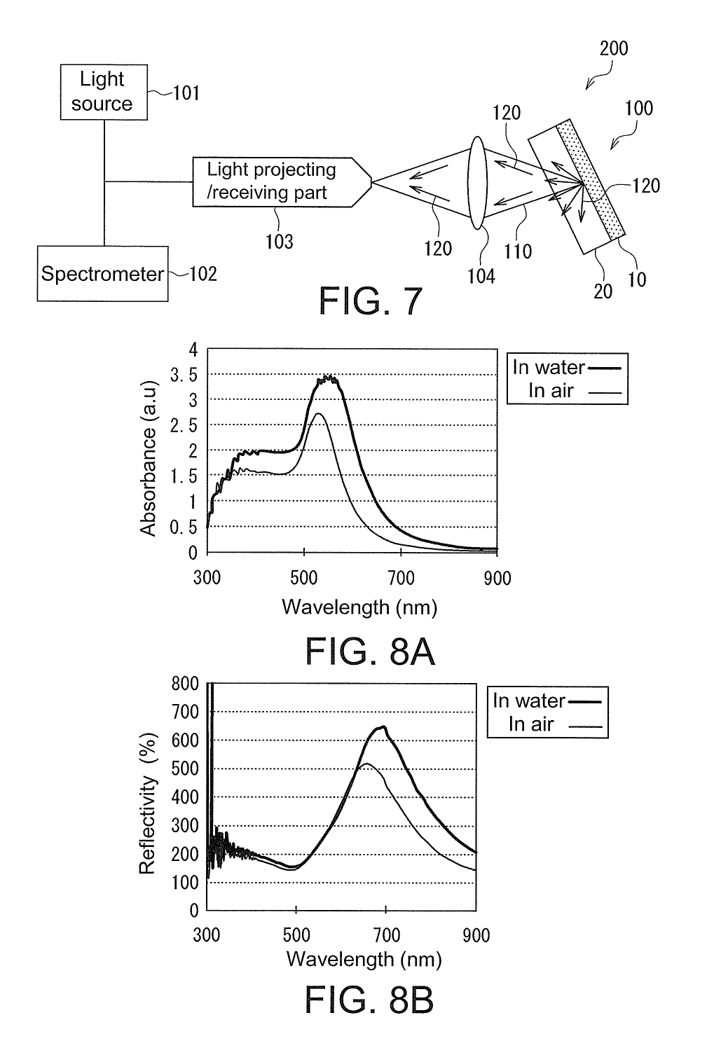

Next, an example of the LSPR sensor utilizing the composite substrate 100 (simply called “LSPR sensor” hereinafter) is described, in reference of FIG. 7. The LSPR sensor 200 includes the composite substrate 100, a light source 101, a spectrometer 102, a light projection/receiving part 103, and a lens 104 as a light concentrating means. The light source emits light having a wavelength inducing LSPR. The spectrometer 102 detects the spectrum of the scattered light received by the light projection/receiving part 103. The light projection/receiving part 103 is possibly constituted by a co-axial Y-type optical fiber capable of projecting and receiving light. The lens 104 is an optical lens concentrating the irradiation light 110 from the light projection/receiving part 103 and the scattered light 120 produced by the nano-composite layer 10 of the composite substrate 100. In the LSPR sensor 200, the light projection/receiving part 103 and the lens 104 are arrange in a manner such that the light is incident in an inclined direction with respect to the lamination direction of the composite substrate 100 that is namely a perpendicular direction with respect to the surface of the nano-composite layer 10 or the surface of the light transmission layer 20. By making the light incident in an inclined direction with respect to the lamination direction of the composite substrate 100, the regular reflected light is not received but only the scattered light is easily concentrated, so the detection sensitivity of the scatter spectrum can be improved. Moreover, the LSPR sensor 200 may also include a light reflection means such as a mirror to adjust the angle of the light incident to the composite substrate 100.

In the LSPR sensor 200, the light transmission layer 20 is arranged facing the lens 104 and the light projection/receiving part 103. Thereby, the irradiation light 110 having been concentrated by the lens 104 is transmitted through the light transmission layer 20 and incident to the nano-composite layer 10. Moreover, a part of the scattered light 120 produced by the LSPR of the nano-composite layer 10 is transmitted through the light transmission layer 20, and a part of the transmitted scattered light 120 is concentrated by the lens 104 and then received by the light projection/receiving part 103. In such case, the light transmission layer 20 function as a measurement window separating the lens 104 and the light projection/receiving part 103 from the sample. That is, in a possible case where the nano-composite layer is used while being exposed in a sample of a gas, a liquid or the like, by disposing the light transmission layer 29, the lens 104 and the light projection/receiving part 103 can be prevented from being exposed in the sample, and the scattered light 120 from the LSPR of the nano-composite layer 10 can be concentrated efficiently.

With the LSPR sensor 200 having the above constitution, an organic substance or an organic substance can be detected based on the change of the scatter spectrum of LSPR, the change of the intensity of the scatter spectrum, or the change of the intensity of the scattered light.

### EXAMPLES

This invention will be specifically described with the following examples, which are not intended to give any limitation on this invention. In the following Examples and Comparative Examples, respective measurements and evaluations are carried out as follows, if not being particularly explained.

[Measurement of the Mean Particle Diameter of Metal Fine-Particles]

In the measurement of the mean particle diameter of the metal fine-particles, the sample was pulverized and dispersed in ethanol, the obtained dispersion liquid was dripped onto a metallic mesh attached with a carbon support film to form a substrate, and the substrate was observed using a transmission electron microscope (TEM; JEM-2000EX made by JEOL Ltd.). Moreover, the mean particle diameter of the metal fine-particles is set to be an area-averaged diameter.

[Measurement of Void Proportion of Metal Fine-Particle Dispersed Layer]

The void proportion of the metal fine-particle dispersed layer was calculated by the following Eq. (A) from the apparent (gross) density of the metal fine-particle dispersed layer calculated from its area, thickness and weight, and the void-free density (real density) calculated from the intrinsic densities and the composition ratio of the material forming the solid framework of the matrix and the metal fine-particles.

Void proportion (%)=(1−gross density/real density)×100 (A)

[Calculation of Content of Metal Fine-Particles Per Unit Area]

The content of the metal fine-particles per unit area was calculated by the following Eq. (B) with the thickness of the metal fine-particle dispersed layer, the volume fraction of the metal fine-particles relative to the metal fine-particle dispersed layer, and the intrinsic density of the metal fine-particle.

Content of the metal fine-particles per unit area (μg/cm²)=the thickness (μm)×the volume fraction (%)×the density (g/cm³) (B)

[Measurement of Absorption Spectrum]

In the measurement of the absorption spectrum, the incident light was incident perpendicularly with respect to the composite substrate 100, and the transmitted light was received. Moreover, an instant multi-channel photo-detection system (MCPR-3700, manufactured by Otsuka Electronics Co. Ltd.) was used as the spectrometer 102.

[Measurement of Scatter Spectrum]

In the measurement of the scatter spectrum, a system having the same constitution of the LSPR sensor 200 of FIG. 7 was used. Moreover, the instant multi-channel photo-detection system (MCPR-3700, manufactured by Otsuka Electronics Co. Ltd.) was used as the spectrometer 102, and a co-axial Y-type optical fiber was used as the light projection/receiving part 103.

### Example 1

In 18 g of boehmite powder (produced by Taimei Chemicals Co., Ltd.; trade name: C-01; mean primary particle diameter: 20 nm; mean secondary particle diameter: 0.1 μm; particle shape: cubic shape), 78.72 g of water and 2.38 g of acetic acid were added, and mechanical stirring was conducted in a rotation speed of 400 rpm for 3 hours to prepare a boehmite dispersion liquid of 18 wt %. Next, to 3.25 g of the boehmite dispersion liquid 1, 4.02 g of ethanol, 1.83 g of a 20 wt % aqueous solution of a polyvinylalcohol (mean molecular weight: 22000; polymerization degree: 500; saponification degree: 88%), 0.06 g of 3-aminopropyltriethoxysilane, and 1.10 g of chloroauric acid tetrahydrate were added to prepare a slurry 1 containing a gold complex. Moreover, when the respective reagents were added respectively, a stirrer was used to stir at a rotation speed of 1000 rpm for 5 minutes.

Next, a transparent glass substrate of 0.7 mm thick was coated with the obtained slurry 1 containing the gold complex using a spin coater (trade name: Spincoater 1H-DX2; manufactured by Mikasa Co., Ltd.), dried at 70° C. for 3 minutes and then at 130° C. for 10 minutes, and then subjected to a heating treatment at 280° C. for 10 minutes and then at 500° C. for 1 minute to form a metal gold fine-particle dispersed layer 1 of 1.80 μm thick that displayed a red color. The metal gold fine-particles formed in the dispersion layer 1 were dispersed entirely independently from each other in the region from the surface portion of the dispersion layer 1 along the thickness direction, with a distance equal to or greater than the particle diameter of the larger one of neighboring metal gold fine-particles. The characteristics of the dispersion layer 1 include:
1) a void proportion of 57.9%;
2) a shape of the metal gold fine-particle being a substantially spherical shape, a mean particle diameter of 35.6 nm, a minimal particle diameter of 9.1 nm, a maximal particle diameter of 73 nm, and a proportion of 98.7% for the particles having particle diameters within the range of 20 to 100 nm; and
3) a volume fraction of the metal gold fine-particles relative to the dispersion layer 1 being 5.1%, a weight fraction of the same being 46.7 wt %, and a content of the metal gold fine-particles per unit area of the dispersion layer 1 being 179 μg/cm².

Moreover, the transmission absorption spectrum of the LSPR of the metal gold fine-particles in the dispersion layer 1 in air was observed to have a peak top at 531 nm, a half-height width of 77 nm, and an absorption peak having a peak-top absorbance of 2.72, and the absorption spectrum in water was observed to have a peak top at 554 nm, and an absorption peak having a peak-top absorbance of 3.54. The peak wavelength variation and the peak intensity variation per unit variation of the refractive index of the observed absorption peak were 67.9 nm and 2.21, respectively.

In addition, the scatter spectrum of the LSPR of the metal gold fine-particles in the dispersion layer 1 in air was observed to have a peak top at 655 nm, a half-height width of 157 nm, and a scatter peak having a peak-top intensity of 5.20, and the scatter spectrum in water was observed to have a peak top at 693 nm, and a scatter peak having a peak-top intensity of 6.50. The peak wavelength variation and the peak intensity variation per unit variation of the refractive index of the observed scatter peak were 115.2 nm and 3.94, respectively. The absorption spectrum and the scatter spectrum observed in Example 1 are shown in FIGS. 8A and 8B, respectively.

### Example 2

A metal gold fine-particle dispersed layer 2 of 1.80 μm thick displaying a red color was formed as in Example 1 except that 3.50 g of a 18 wt % boehmite dispersion liquid, 4.33 g of ethanol, 1.97 g of a 20 wt % aqueous solution of a polyvinylalcohol, 0.06 g of 3-aminopropyltriethoxysilane, and 0.92 g of chloroauric acid tetrahydrate were used to prepare a gold complex-containing slurry 2. The metal gold fine-particles formed in the dispersion layer 2 were dispersed entirely independently from each other in the region from the surface portion of the dispersion layer 2 along the thickness direction, with a distance equal to or greater than the particle diameter of the larger one of neighboring metal gold fine-particles. The characteristics of the dispersion layer 2 include:
1) a void proportion of 58.6%;
2) a shape of the metal gold fine-particle being a substantially spherical shape, a mean particle diameter of 24.2 nm, a minimal particle diameter of 6.0 nm, a maximal particle diameter of 91.2 nm, and a proportion of 96.1% for the particles having particle diameters within the range of 20 to 100 nm; and
3) a volume fraction of the metal gold fine-particles relative to the dispersion layer 2 being 4.0%, a weight fraction of the same being 40.5 wt %, and a content of the metal gold fine-particles per unit area of the dispersion layer 2 being 140 μg/cm².

### Example 3

A metal gold fine-particle dispersed layer 3 of 1.80 μm thick displaying a red color was formed as in Example 1 except that 3.50 g of a 18 wt % boehmite dispersion liquid, 4.33 g of ethanol, 1.97 g of a 20 wt % aqueous solution of a polyvinylalcohol, 0.06 g of 3-aminopropyltriethoxysilane, and 0.79 g of chloroauric acid tetrahydrate were used to prepare a gold complex-containing slurry 3. The metal gold fine-particles formed in the dispersion layer 3 were dispersed entirely independently from each other in the region from the surface portion of the dispersion layer 3 along the thickness direction, with a distance equal to or greater than the particle diameter of the larger one of neighboring metal gold fine-particles. The characteristics of the dispersion layer 3 include:
1) a void proportion of 59.0%;
2) a shape of the metal gold fine-particle being a substantially spherical shape, a mean particle diameter of 28.9 nm, a minimal particle diameter of 9.1 nm, a maximal particle diameter of 62.6 nm, and a proportion of 97.8% for the particles having particle diameters within the range of 20 to 100 nm; and
3) a volume fraction of the metal gold fine-particles relative to the dispersion layer 3 being 3.5%, a weight fraction of the same being 36.9 wt %, and a content of the metal gold fine-particles per unit area of the dispersion layer 3 being 121 μg/cm².

### Example 4

A metal gold fine-particle dispersed layer 4 of 1.80 μm thick displaying a red color was formed as in Example 1 except that 3.75 g of a 18 wt % boehmite dispersion liquid, 4.64 g of ethanol, 2.11 g of a 20 wt % aqueous solution of a polyvinylalcohol, 0.07 g of 3-aminopropyltriethoxysilane, and 0.70 g of chloroauric acid tetrahydrate were used to prepare a gold complex-containing slurry 4. The metal gold fine-particles formed in the dispersion layer 4 were dispersed entirely independently from each other in the region from the surface portion of the dispersion layer 4 along the thickness direction, with a distance equal to or greater than the particle diameter of the larger one of neighboring metal gold fine-particles. The characteristics of the dispersion layer 3 include:
1) a void proportion of 59.3%;
2) a shape of the metal gold fine-particle being a substantially spherical shape, a mean particle diameter of 40.4 nm, a minimal particle diameter of 8.9 nm, a maximal particle diameter of 68.1 nm, and a proportion of 99.8% for the particles having particle diameters within the range of 20 to 100 nm; and
3) a volume fraction of the metal gold fine-particles relative to the dispersion layer 4 being 2.9%, a weight fraction of the same being 32.7 wt %, and a content of the metal gold fine-particles per unit area of the dispersion layer 4 being 101 μg/cm².

### Example 5

A metal gold fine-particle dispersed layer 5 of 1.80 μm thick exhibiting a red color was formed as in Example 1 except that 3.75 g of a 18 wt % boehmite dispersion liquid, 4.64 g of ethanol, 2.11 g of a 20 wt % aqueous solution of a polyvinylalcohol, 0.07 g of 3-aminopropyltriethoxysilane, and 0.56 g of chloroauric acid tetrahydrate were used to prepare a gold complex-containing slurry 5. The metal gold fine-particles formed in the dispersion layer 5 were dispersed entirely independently from each other in the region from the surface portion of the dispersion layer 5 along the thickness direction, with a distance equal to or greater than the particle diameter of the larger one of neighboring metal gold fine-particles. The characteristics of the dispersion layer 5 include:
1) a void proportion of 59.7%;
2) a shape of the metal gold fine-particle being a substantially spherical shape, a mean particle diameter of 34.3 nm, a minimal particle diameter of 6.9 nm, a maximal particle diameter of 54.8 nm, and a proportion of 99.6% for the particles having particle diameters within the range of 20 to 100 nm; and
3) a volume fraction of the metal gold fine-particles relative to the dispersion layer 5 being 2.4%, a weight fraction of the same being 28.0 wt %, and a content of the metal gold fine-particles per unit area of the dispersion layer 5 being 82 μg/cm².

### Example 6

A metal gold fine-particle dispersed layer 6 of 1.80 μm thick displaying a red color was formed as in Example 1 except that 3.75 g of a 18 wt % boehmite dispersion liquid, 4.64 g of ethanol, 2.11 g of a 20 wt % aqueous solution of a polyvinylalcohol, 0.07 g of 3-aminopropyltriethoxysilane, and 0.42 g of chloroauric acid tetrahydrate were used to prepare a gold complex-containing slurry 6. The metal gold fine-particles formed in the dispersion layer 6 were dispersed entirely independently from each other in the region from the surface portion of the dispersion layer 6 along the thickness direction, with a distance equal to or greater than the particle diameter of the larger one of neighboring metal gold fine-particles. The characteristics of the dispersion layer 6 include:
1) a void proportion of 60.1%;
2) a shape of the metal gold fine-particle being a substantially spherical shape, a mean particle diameter of 27.3 nm, a minimal particle diameter of 15.5 nm, a maximal particle diameter of 43.3 nm, and a proportion of 97.4% for the particles having particle diameters within the range of 20 to 100 nm; and
3) a volume fraction of the metal gold fine-particles relative to the dispersion layer 6 being 1.8%, a weight fraction of the same being 22.6 wt %, and a content of the metal gold fine-particles per unit area of the dispersion layer 6 being 61 μg/cm².

### Example 7

A metal gold fine-particle dispersed layer 7 of 1.80 μm thick exhibiting a red color was formed as in Example 1 except that 3.75 g of a 18 wt % boehmite dispersion liquid, 4.64 g of ethanol, 2.11 g of a 20 wt % aqueous solution of a polyvinylalcohol, 0.07 g of 3-aminopropyltriethoxysilane, and 0.28 g of chloroauric acid tetrahydrate were used to prepare a gold complex-containing slurry 7. The metal gold fine-particles formed in the dispersion layer 7 were dispersed entirely independently from each other in the region from the surface portion of the dispersion layer 7 along the thickness direction, with a distance equal to or greater than the particle diameter of the larger one of neighboring metal gold fine-particles. The characteristics of the dispersion layer 7 include:
1) a void proportion of 60.4%;
2) a shape of the metal gold fine-particle being a substantially spherical shape, a mean particle diameter of 20.0 nm, a minimal particle diameter of 4.4 nm, a maximal particle diameter of 47.8 nm, and a proportion of 92.8% for the particles having particle diameters within the range of 20 to 100 nm; and
3) a volume fraction of the metal gold fine-particles relative to the dispersion layer 7 being 1.2%, a weight fraction of the same being 16.3 wt %, and a content of the metal gold fine-particles per unit area of the dispersion layer 7 being 41 μg/cm².

Moreover, the transmission absorption spectrum of the LSPR of the metal gold fine-particles in the dispersion layer 7 in air was observed to have a peak top at 521 nm, a half-height width of 65 nm, and an absorption peak having a peak-top absorbance of 0.65, and the absorption spectrum in water was observed to have a peak top at 534 nm, and an absorption peak having a peak-top absorbance of 1.08. The peak wavelength variation and the peak intensity variation per unit variation of the refractive index of the observed absorption peak were 42.4 nm and 1.30, respectively.

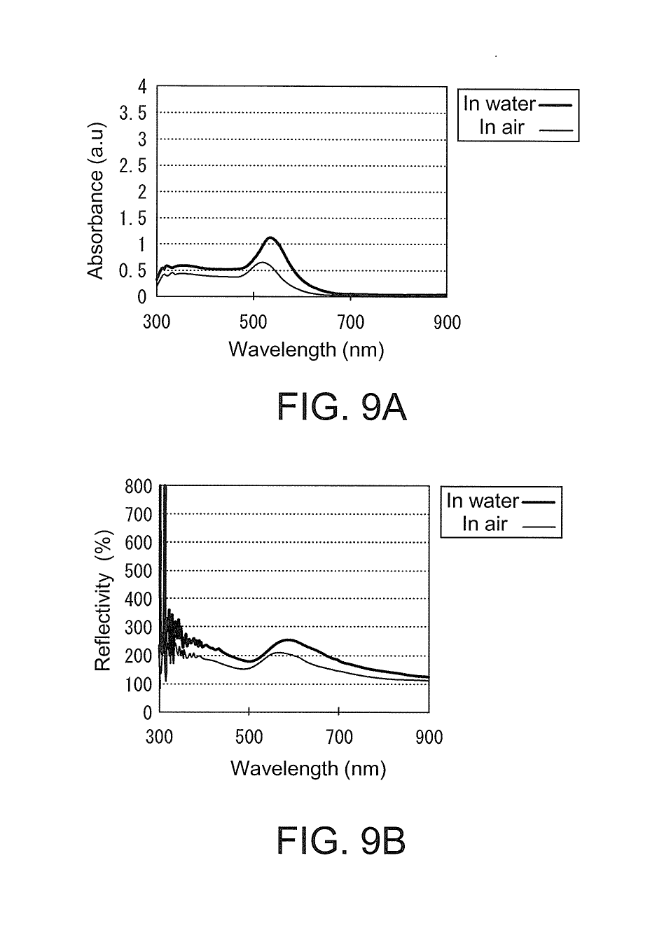

In addition, the scatter spectrum of the LSPR of the metal gold fine-particles in the dispersion layer 7 in air was observed to have a peak top at 568 nm, a half-height width of 129 nm, and a scatter peak having a peak-top intensity of 2.11, and the scatter spectrum in water was observed to have a peak top at 584 nm, and a scatter peak having a peak-top intensity of 2.55. The peak wavelength variation and the peak intensity variation per unit variation of the refractive index of the observed scatter peak were 49 nm and 1.33, respectively. The absorption spectrum and the scatter spectrum observed in Example 7 are shown in FIGS. 9A and 9B, respectively.

### Example 8

A metal gold fine-particle dispersed layer 8 of 0.50 μm thick displaying a red color was formed as in Example 1 except that 3.50 g of a 18 wt % boehmite dispersion liquid, 4.33 g of ethanol, 1.97 g of a 20 wt % aqueous solution of a polyvinylalcohol, 0.06 g of 3-aminopropyltriethoxysilane, and 1.84 g of chloroauric acid tetrahydrate were used to prepare a gold complex-containing slurry 8. The metal gold fine-particles formed in the dispersion layer 8 were dispersed entirely independently from each other in the region from the surface portion of the dispersion layer 8 along the thickness direction, with a distance equal to or greater than the particle diameter of the larger one of neighboring metal gold fine-particles. The characteristics of the dispersion layer 8 include:
1) a void proportion of 56.6%;
2) a shape of the metal gold fine-particle being a substantially spherical shape, a mean particle diameter of 61.2 nm, a minimal particle diameter of 17.9 nm, a maximal particle diameter of 131.1 nm, and a proportion of 92.0% for the particles having particle diameters within the range of 20 to 100 nm; and
3) a volume fraction of the metal gold fine-particles relative to the dispersion layer 8 being 7.7%, a weight fraction of the same being 57.7 wt %, and a content of the metal gold fine-particles per unit area of the dispersion layer 8 being 75 μg/cm².

### Comparative Example 1

A metal gold fine-particle dispersed layer 9 of 0.10 μm thick displaying a red color was formed as in Example 1 except that 3.00 g of a 18 wt % boehmite dispersion liquid, 7.42 g of ethanol, 3.71 g of pure water 1.69 g of a 20 wt % aqueous solution of a polyvinylalcohol, 0.05 g of 3-aminopropyltriethoxysilane, and 1.01 g of chloroauric acid tetrahydrate were used to prepare a gold complex-containing slurry 9. The metal gold fine-particles formed in the dispersion layer 9 were dispersed entirely independently from each other in the region from the surface portion of the dispersion layer 9 along the thickness direction, with a distance equal to or greater than the particle diameter of the larger one of neighboring metal gold fine-particles. The characteristics of the dispersion layer 9 include:
1) a void proportion of 57.9%;
2) a shape of the metal gold fine-particle being a substantially spherical shape, a mean particle diameter of 12.8 nm, a minimal particle diameter of 4.1 nm, a maximal particle diameter of 30.0 nm, and a proportion of 46.3% for the particles having particle diameters within the range of 20 to 100 nm; and
3) a volume fraction of the metal gold fine-particles relative to the dispersion layer 9 being 5.1%, a weight fraction of the same being 46.7 wt %, and a content of the metal gold fine-particles per unit area of the dispersion layer 9 being 10 μg/cm².

Moreover, the transmission absorption spectrum of the LSPR of the metal gold fine-particles in the dispersion layer 9 in air was observed to have a peak top at 526 nm, a half-height width of 70 nm, and an absorption peak having a peak-top absorbance of 0.21, and the absorption spectrum in water was observed to have a peak top at 538 nm, and an absorption peak having a peak-top absorbance of 0.32. The peak wavelength variation and the peak intensity variation per unit variation of the refractive index of the observed absorption peak were 36.2 nm and 0.33, respectively.

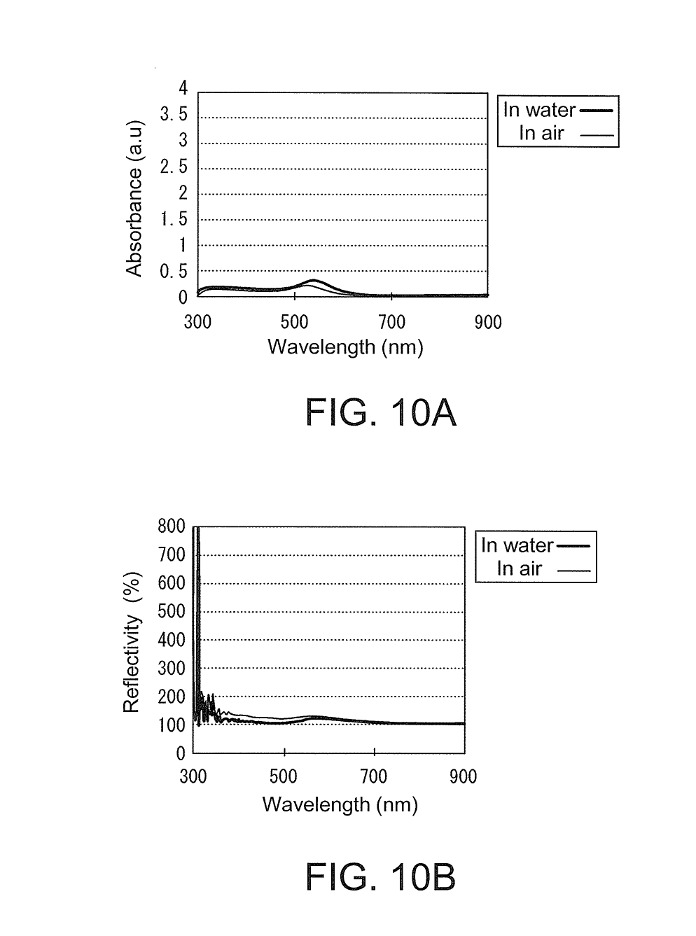

In addition, the scatter spectrum of the LSPR of the metal gold fine-particles in the dispersion layer 9 in air was observed to have a peak top at 565 nm, a half-height width of 134 nm, and a scatter peak having a peak-top intensity of 1.29, and the scatter spectrum in water was observed to have a peak top at 578 nm, and a scatter peak having a peak-top intensity of 1.22. The peak wavelength variation and the peak intensity variation per unit variation of the refractive index of the observed scatter peak were 39 nm and −0.23, respectively. The absorption spectrum and the scatter spectrum observed in Comparative Example 1 are shown in FIGS. 10A and 10B, respectively.

This invention has been disclosed above in the preferred embodiments, but is not limited to those. It is known to persons skilled in the art that some modifications and innovations may be made without departing from the spirit and scope of this invention. Hence, the scope of this invention should be defined by the following claims.

What is claimed is:

1. A composite substrate, comprising:
a metal fine-particle dispersed layer; and
a light transmission layer laminated with the metal fine-particle dispersed layer,
wherein the metal fine-particle dispersed layer has features a) to f), in which
a) the metal fine-particle dispersed layer comprises a matrix having a solid framework and voids defined by the solid framework, and metal fine-particles immobilized in the solid framework,
b) the solid framework contains aluminum oxyhydroxide or an alumina hydrate to form a three-dimensional network structure,
c) the metal fine-particles have a mean particle diameter in a range of 20 to 100 nm, with a proportion of 50% or more thereof having particle diameters in the range of 20 to 100 nm,
d) the metal fine-particles are separated from each other with a distance that is equal to or greater than a particle diameter of a larger one of neighboring fine-particles,
e) the metal fine-particles have portions exposed in the voids of the matrix and are three-dimensionally dispersed in the matrix, and
f) the metal fine-particle dispersed layer has a thickness in a range of 0.5 to 5 μm and a metal fine-particle content with a range of 22 to 900 μg/cm².

2. The composite substrate of claim 1, wherein a void proportion of the metal fine-particle dispersed layer is within a range of 15 to 95%.

3. The composite substrate of claim 1, wherein a volume fraction of the metal fine-particles in the metal fine-particle dispersed layer in within a range of 1 to 9% relative to the metal fine-particle dispersed layer.

4. The composite substrate of claim 1, wherein the metal fine-particles include gold (Au) or silver (Ag).

5. The composite substrate of claim 1, wherein the metal fine-particles interact with light having a wavelength of 380 nm or longer to induce a local surface plasmon resonance (LSPR).

6. An LSPR sensor, comprising:
the composite substrate of claim 1;
a light source irradiating the composite substrate with light;
a light receiving part receiving a scattered light from LSPR of the metal fine-particles in the composite substrate; and
a spectrometer measuring a scatter spectrum of the scattered light, or a photo-detector measuring an intensity of the scattered light.

7. The LSPR sensor of claim 6, further comprising a means for concentrating the scattered light.

8. The LSPR sensor of claim 6, further comprising a means for concentrating the irradiation light.

9. The LSPR sensor of claim 6, wherein the irradiation light from the light source is inclined with respect to a lamination direction of the composite substrate.

10. The LSPR sensor of claim 6, wherein the light irradiation and the measurement of the scatter spectrum are done through the light transmission layer.

11. A method of using an LSPR sensor, comprising: exposing, in the atmosphere or in a gas, the metal fine-particle dispersed layer in the LSPR sensor of claim 6.

12. A method of using an LSPR sensor, comprising: exposing, in a liquid, the metal fine-particle dispersed layer in the LSPR sensor of claim 6.

13. A method for detecting an inorganic or organic substance, comprising:
providing the LSPR sensor of claim 6; and
measuring a change of the scatter spectrum of the scattered light from the LSPR, a change of an intensity of the scatter spectrum of the scattered light from the LSPR, or a change of the intensity of the scattered light from the LSPR.
